(19) United States
(12) Patent Application Publication
(10) Pub. No.: US 2021/0092978 A1
(43) Pub. Date: Apr. 1, 2021

(54) Edible Pet Chew with Meat Analogue Member and Method for Making the Same

(71) Applicant: Shanghai Sunlight Innov Trading Co., Ltd., Shanghai (CN)

(72) Inventors: Guangqiang XU, Shanghai (CN); Jing GUO, Shanghai (CN)

(21) Appl. No.: 16/718,149

(22) Filed: Dec. 17, 2019

(30) Foreign Application Priority Data
Sep. 30, 2019 (CN) 201910937656.9

(51) Int. Cl. A23K 10/30; A23K 50/40; A23K 20/147; A23K 20/174; A23K 40/25; A23K 30/20

(52) U.S. Cl. CPC A23K 10/30; A23K 50/40; A23K 30/20; A23K 20/174; A23K 40/25; A23K 20/147

(57) ABSTRACT

An edible pet chew incorporates a chewy sheet member and a plant based meat analogue member being assembled together. The meat analogue member imitates an appearance and texture of meat jerky and may have an internal aligned fibrous structure. In another aspect of the present invention, the edible pet chew is a rawhide munchy product including a plurality of rawhide bits, a plurality of meat analogue tiny chunks and a binder. In yet another aspect of the present invention, the edible pet chew includes a plant based extruded or injection-formed chewy piece member and a meat analogue member, and the meat analogue member wraps about the chewy piece member.

### CROSS REFERENCE OF RELATED APPLICATION

This is a non-provisional application that claims priority to Chinese application number CN201910937656.9, filing date Sep. 30, 2019, the entire content of which is expressly incorporated herein by reference.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The field of the present invention relates to an edible pet chew and a method for making the same. More particularly, the present invention relates to an edible pet chew primarily for dogs that is safe and entertaining, and satisfies their instinctive needs to chew.

### Description of Related Arts

Dog is not only a carnivorous animal, but also an omnivorous one. Visiting to a pet store or supermarket makes it readily apparent that there's a wide selection of dried meat (especially jerky products , such as chicken jerky) dog treat/chew products or dog treat/chew products with dried meat member, such as chicken and rawhide combination chews, beef jerky strip and vegetable dental chew combination, chicken stick made of chicken slurry composite and dog cookies with duck strip wrapped. It is noted that dog treats and dog chews that are addressed in the present invention are of dry feeding stuffs (dry feed) rather than moist feed such as wet treat or wet feed, substantially with a moisture content less than 25%. Dog chews always are referring to dry ones in all circumstance.

With irresistible inherent taste, these meat (including poultry meat, say chicken) related products are much welcome by carnivorous pets, especially dogs, consuming millions of tons of meat raw materials every year. However, many significant disadvantages of traditional meat products (including pet treat products) have been becoming more and more concerned by people which includes: A). Indeed, livestock/poultry raising industry is really not environment friendly. It hugely releases greenhouse gases which contribute to acceleration to worldwide climate change. It's a heavily water consuming industry hurting clean water resources, which takes an average 308 gallons of water to produce just 1 pound of beef, according to the U.S.D.A. And it is also depleting farmland resources. B). High risk of antibiotics entering their bodies when dogs eat them. C). Meat has high cholesterol content which isn't healthy to dogs. And it potentially has significant amount of fat. D). May cause heart disease and certain cancer. E). May cause bad breath for dogs F). Relatively harder than plant food for dogs to digest making a burden to stomach. G). A risk of salmonella contamination. As many people understand, in every year, meat salmonella contamination incidents happen from time to time in different countries, where some incidents may have killed beloved dogs.

Prior arts disclosed foods (foods for both human and animal feed) with meat analogue elements. Attention is therefore directed to the following disclosures: U.S. Pat. No. 3,836,677A “Process for making simulated meat and cheese products”; U.S. Pat. No. 6,635,301B1 “Method and apparatus for the manufacture of meat”; U.S. application Ser. No. 10/535,121 “Meat analogue of authentic appearance”; U.S. application Ser. No. 10/817,741 “High soy protein nuggets and applications in food products”; U.S. application Ser. No. 14/752,540 “Methods and compositions for consumables”; U.S. application Ser. No. 15/509,186 “An inclusion containing proteinaceous meat analogue having an improved texture and an extended shelf life”; U.S. application Ser. No. 15/672,579 “Secretion of heme-containing polypeptides”. These don't belong to the specific kind of pet chew as the present invention may do.

Based on moisture content, pet treat is divided into two categories, dry treat and wet treat. Edible pet chew is a special kind of pet treat as well as a toy, which is both digestible and functional such as entertaining, jaw exercising, tooth cleaning, fresh breath and keeping them busy. It should be noted that all pet chews are dry products, which a wet treat cannot make.

In the pet food (including treat/chew) industry, some pet food products appeared by introducing meat analogue elements into pet foods as a replacement or extender to traditional meat ones. A variety of disclosures exist pertinent to the development of the pet food. Attention is also directed to the following disclosures: U.S. Pat. No. 3,984,576A “Meatless Marbled semi-moist pet food”; U.S. Pat. No. 7,604,829B2 “Canned pet food with sliced meat analogue”; U.S. application Ser. No. 10/527,473 “Pet food product and method of producing same”; U.S. application Ser. No. 12/370,314 “Meat Analogue Product”; U.S. application Ser. No. 15/569,622 “Wet food with meat analogue”; EPO App. No. EP17711010.3A “Moist pet food comprising a proteinaceous meat analogue having an improved texture”; U.S. application Ser. No. 15/946,361 “Pseudo-loaf food compositions”; U.S. App. No. 20070292594 “plant material pet treat”. Since these aforementioned prior arts are wet food or canned food, they don't belong to the specific kind of pet chew as the present invention may do.

U.S. application Ser. No. 12/663,394 (also a PCT No. PCT/AU2008/000853) entitled “meat analogue with external texture”, filed on Jun. 13, 2008 by Redman, discloses a method to manufacture a meat analogue product with external texture and the surface has a higher protein proportion than the internal. However, it is not a pet CHEW product and fails to disclose any additional chewy member other than the meat analogue to fulfill a pet chew or pet treat. Further it fails to disclose a meat-free meat analogue.

U.S. Pat. No. 6,309,682B1 by Denis Janot filed on Jan. 31, 2000, discloses a dry lamellar-structure pet food product. It's a food composition to make a meat analogue as dry pet food and processing method. However, it isn't a pet CHEW product and fails to disclose any additional member other than the meat analogue to fulfill a pet chew or pet treat. Further it fails to disclose a meat-free meat analogue.

U.S. Pat. No. 7,691,426 by Axelrod filed on Jun. 9, 2006, discloses a pet chew with an edible resin and rawhide. The edible resin may be shaped to sheets, strips, cylinders, etc. However, although the edible resin may include starch or gluten, vegetable based protein, it did not disclose anything about meat analogue or textured vegetable protein. And it is silent that the edible resin has any fibrous structure texture intended to resemble meat jerky. Further it is silent that the edible resin is a textured vegetable protein (TVP) material. Further, it is silent about any meat-free meat analogue member. It doesn't include any of the essential features that the present invention may do.

U.S. application Ser. No. 11/995,653 by Patrick Pibarot filed on Jun. 30, 2006, discloses a method for preparing plasticized wheat gluten compositions for pet food and pet treat applications. It yet merely discloses a plasticized wheat gluten composition preparation. However, it fails to disclose any additional member other than the plasticized gluten composition to fulfill a pet chew or pet treat. Further, it fails to disclose a meat-free meat analogue. Attention is also directed to U.S. application Ser. No. 16/154,219 entitled “edible pet chew and method of making the same”.

U.S. Pat. No. 8,257,775 filed on Mar. 20, 2007 by Axelrod, discloses a molded products based upon textured vegetable protein (TVP). It mentioned that the molded composition includes textured vegetable protein as one ingredient distributed to the molded product body (note Axelrod taught that TVP is employed as an ingredient or raw material to form the product, rather than an individual MEMBER/component to form a product). However, based on its injection process which involves a melting procedure, the textured vegetable protein ingredient definitely will lose its initial fibrous structure in finished products. Thus it fails to teach a finished product with a textured vegetable protein member in initial “textured” state (the initial textured state with internal aligned fibrous structure) as the present invention may do, although its raw material might take fibrous structure material initially. It is silent about an individual meat analogue member such as a textured vegetable protein member serving as a primary component to form a pet chew. Furthermore, it merely teaches a molded product formulated with textured vegetable protein ingredient, but it is silent regarding any additional individual chewy sheet member, such as traditional rawhide sheet, present in the pet chew product working as an essential chew mater providing substantial chew function to the whole pet chew product, silent about any wrapping relationship between a chewy sheet and TVP member, and silent that its molded product is meat free.

U.S. Pat. No. 8,124,156, filed on May. 10, 2007 by Axelrod, merely discloses an injection molding processes to form a molded multi-layered dog chew with at least two different compositions to feed corresponding two molds, where one of the multi compositions may be textured vegetable protein based. It mentions that one composition material may include “rawhide” ingredient, however, the composition with “rawhide” ingredient is not disclosed with the feature of a chewy “sheet” member. The composition with “rawhide” ingredient it applies doesn't refer to the kind of rawhide sheet as the present invention may do, where the kind of rawhide sheet can individually form a rawhide sheet dog chew, for example a rectangular rawhide sheet sized 3 cm×20 cm. Since injection molding equipment nozzle can't take any large particles, the composition material with “rawhide” ingredient and other ingredients (such as a binder and starch) together must be pre-treated by for example comminuting/granulating before entering injection machine, and then heated in an injection machine and melted/gelatinized to form a paste like composition material with rawhide ingredient before its being released from the injection machine. Thus the composition material with “rawhide” ingredient that it discloses finally results in a gelatinized rawhide-invisible mater, for example in a chunk shape. It fails to disclose that the melted/gelatinized composition with “rawhide” ingredient is finally in a sheet form which is an essential feature of traditional rawhide sheet. To a consumer, the gelatinized composition material with rawhide ingredient is visually unidentifiable as a rawhide product since it has very different physical property or chewing property vs. traditional rawhide sheet and has nothing to do with the rawhide sheet as the present invention discloses. Additionally, it mentioned one of the multi compositions may include textured vegetable protein ingredient. However, based on its injection process which involves a melting procedure, the textured vegetable protein ingredient definitely will lose its initial fibrous structure in finished products. Thus it fails to teach a finished product with a vegetable protein member with fibrous structure as the present invention may do. Furthermore, it is also silent in: regarding a chewy sheet member; regarding a member of meat-free textured vegetable protein with internal fibrous structure; regarding wrapping relationship between the chewy sheet and TVP member; regarding that the finished product is a rawhide dog chew which is primarily formed by rawhide SHEET as one essential component of it.

U.S. Pat. No. 8,677,943, filed on Jul. 10, 2012 by Axelrod, discloses a pet chew with interwoven strips of Edible Resin. The edible resin may be shaped strips. However, although the edible resin may include starch, gluten and vegetable based protein, it didn't disclose anything about meat analogue. Edible resin with cellulose fiber ingredient serving as a sort of binder ingredient binding primary ingredients together does not result with a member with fibrous structure. And it is silent that the edible resin has any fibrous structure texture intended to resemble meat jerky. Further it is silent that the edible resin is a Textured Vegetable Protein (TVP) material. It is silent about any meat-free meat analogue member. It doesn't include the essential features that the present invention may have.

In the pet chew field, all prior arts fail to disclose an excellent pet chew product that is excellent in chewing longevity and palatability, attractive to both dog owner and dog, marketable and welcomed by dog owners and dogs pertinent to meat analogue.

Drawbacks of products solely made of meat analogue are disclosed by the inventor of the present invention that, due to its nature, meat analogue generally either is soft/weak or fails to provide sufficient chewing longevity. It determines that meat analogue cannot form a pet chew solely since, for a pet chew, it is absolutely necessary to offer chew longevity. In order to form a pet chew product with a meat analogue member, the present invention may introduce an additional chewy sheet member which substantially offers chew longevity to the whole product.

Now regarding the pet chew field that the present invention is intended to disclose related to. Domestic pets, primarily dogs, have an instinct to chew which keeps their teeth healthy, exercises their jaws and teeth, and keeps teeth clean. “Pet Chew” products have been introduced to the market for many years to accommodate that instinctive urge to chew in a healthy direction.

“Pet Chews” are intended to be chewed by a pet/dog for an extended period of time, being distinguished from regular “pet treats”. Regular “pet treats” are intended to be chewed by a pet/dog for a relatively short period of time and digested.

One existing important category of a typical Edible “Pet Chew” is the one that is made of animal skin, such as Traditional Rawhide/Porkhide Sheet. Of these types of pet chew, “rawhide sheet” is a commonly used material which is thin, chewy, malleable and long-lasting for chewing. With these excellent qualities/characteristics, “rawhide sheet” is extensively used to produce dog chews in the existing market creating thousands of “rawhide” dog chew products.

Pet Chew consisting solely of rawhide/porkhide sheets may be chewed for sufficiently long time and can be digested. However, many dogs find these pet chews lack of substantial flavor and scent. Accordingly, many dogs lose interest with these rawhide pet chews after a while and will at most only chew on them for short periods of time and abandon. Some existing products consisting solely of rawhide/porkhide are improved by adding additional flavorings, such as an artificial peanut flavor, into the rawhide after it is hardened, but it cannot improve the palatability of rawhide significantly.

Some other prior art rawhide chew products are applied with meat material on the surface of rawhide components where meat material works as attractant enticing dogs to chew on. Dog starts with the meat material piece by gnawing and easily leaves the remnant rawhide pieces as soon as it finishes with the meat part on its surface.

U.S. Pat. No. 5,673,653 by Sherrill, filed on Sep. 26, 1996, discloses an edible pet chew wrapping jerky with rawhide sheet, so as to attract pets to chew. It finds an excellent way to make the pet chews made of traditional rawhide sheet continuously attractive to dogs throughout a whole chewing activity, revolutionarily improving its palatability to pets. But, due to meat jerky as one major component in its pet chew, it unfortunately still is involved in the concerns of aforementioned drawbacks A-G of meat products.

Another form of rawhide based dog chew is so called “rawhide munchy” chew which generally is made of animal hide bits and binder or adhesive such as glutinous rice paste, starch and gelatin holding the animal hide bits together firmly. Animal hide bits are prepared by grinding hide sheet to small pieces. In order to improve the palatability of this kind of rawhide munchy product, U.S. Pat. No. 6,584,938B2 by Sherrill discloses a rawhide munchy item with a flavor product (most preferably meat jerky bits) interspersed into the body of the munchy part. It offers a good idea to continuously entice a dog's curiosity and keep it chewing for an extended period of time, but due to meat product as one major component in its pet chew, it unfortunately still is involved in the concerns of aforementioned drawbacks A-G of meat products.

U.S. Pat. No. 6,777,203B2 by Mark Stern, filed on Nov. 21, 2006, discloses a pet chew formed from a plant based chewy sheet and another edible sheet material assembled together in a relationship. However, it fails to disclose a meat analogue component appearing in the pet chew. Further, it fails to mention that the whole pet chew product is free of meat ingredient including the plant based chewy sheet member. Its related U.S. Pat. No. 8,455,025B2 by Mark Stern, filed on Apr. 21, 2010, discloses a pet chew made of a single sheet component. Apparently, its disadvantages include at least: A). Due to a single sheet configuration, it lacks additional attractant sheet member to entice a dog to chew other than the plant based sheet member. B). Single sheet configuration may appear boring for some dogs as they can't find anything new while advancing their chewing activity. Furthermore, it fails to disclose a meat analogue component appearing in the pet chew.

It is disclosed by the inventor of the present invention that due to its nature, meat analogue generally either is weak/soft or fails to provide sufficient chewing longevity. It determines that meat analogue cannot form a quality pet chew solely since, as a pet chew, it's absolutely necessary to offer chew longevity. On the other hand, a pet chew solely with a chewy sheet member (such as rawhide or plant based sheet) is thought to be insufficient because it either cannot provide necessary attractant urging dogs to chew on, or cannot provide an additional interesting new mater urging dogs to find while being gnawed.

Accordingly, what is needed is an edible pet chew to overcome the problems and disadvantages of the prior arts.

### SUMMARY OF THE PRESENT INVENTION

An objective of the present invention is to provide an edible pet chew product intended to be chewed by a dog for an extended period of time before being digested. The pet chew may keep the dog's teeth clean, freshen breath and exercise its jaws.

Another objective of the present invention is to provide an edible pet chew with a chewy sheet member. The chew function of the edible pet chew product is substantially or primarily fulfilled by the chewy sheet member.

Another objective of the present invention is to provide an edible pet chew free of meat ingredient. Even further, it may be free of meat by-products ingredient.

Another objective of the present invention is to provide an edible pet chew with an essential member of plant based meat analogue, imitating a piece of whole muscle meat jerky, which is preferably meat-free. The imitation presented by the meat analogue at least includes appearance and texture of meat, particularly fibrous structured texture of whole muscle meat jerky.

Another objective of the present invention is to provide an edible pet chew with an essential member of meat analogue which is preferably plant protein based, more particularly is a “textured vegetable protein” material.

Another objective of the present invention is to provide an edible pet chew with a high protein member.

Another objective of the present invention is to provide an edible pet chew combining a meat analogue and an additional chewy member, in which the latter fulfills chew function to the product. It overcomes the drawbacks of a product solely made of a meat analogue.

Another objective of the present invention is to provide an edible pet chew incorporating/combining a meat analogue member and a chewy sheet member. It overcomes the drawbacks of a product formed solely of a meat analogue or solely of chewy sheet. A pet chew solely with a chewy sheet member (such as rawhide or plant based sheet) is thought to be insufficient because it either cannot provide necessary attractant urging dogs to chew on, or cannot provide an additional interesting new mater urging dogs to find.

In one aspect of the present invention, an edible pet chew is provided incorporating/combining an animal hide sheet (rawhide) and a meat-free meat analogue member. Preferably in this aspect, the meat analogue member is substantially wrapped in the hide sheet member with a portion preferably protruding outside and preferably at least a portion of the meat analogue is concealed by the animal hide sheet. The meat analogue is significantly more palatable to dogs than the hide. The presence of the meat analogue member can encourage dogs to chew and the dogs will eat starting with the animal hide before their reaching the inner meat analogue member. Dogs are attracted by the meat analogue wrapped therein but they can't reach it unless they ingest hide which conceals it. In this pattern, the pet chew achieves continuing attraction to dogs during their chewing time.

In one aspect of the present invention, a rawhide dog chew is created with a meat-free meat analogue member being wrapped into a rawhide sheet with a portion of the meat analogue member preferably protruding at the seam of the rawhide piece. In this configuration, the rawhide sheet substantially forms the outer layer of the product including a longitudinal seam therein. The meat-free meat analogue member forms an inner member and is substantially retained within the outer layer. A portion of the inner member extends through the seam in the outer layer and is partially exposed outside the outer layer. Preferably, there are a plurality of meat analogues wrapped in the animal hide sheet.

In another aspect of the present invention, an edible pet chew is provided incorporating/combining an animal hide sheet member and a meat-free meat analogue member, where the two members are placed against each other into a composite assembly with the first member and the second forming alternating layers in the composite assembly in finished product.

In another aspect of the present invention, an edible pet chew is provided incorporating a rawhide sheet member and a meat-free meat analogue member, where the meat-free meat analogue member wraps about the rawhide sheet member.

In another aspect of the present invention, an edible pet chew is provided in a form of rawhide munchy product which incorporates/combines bits made of animal hide sheet and small chunks/bits made of plant based meat-free meat analogue. The meat analogue chunks are interspersed into the body of the pet chew product.

Another objective of the present invention is to provide an edible pet chew incorporating a plant based chewy sheet member and a meat-free meat analogue member, which are assembled together.

In one aspect of the present invention, a plant based chewy sheet dog chew is created with a meat-free meat analogue member wrapping around a plant based chewy sheet. A portion of the chewy sheet member is exposed without being covered by the meat analogue member.

In another aspect of the present invention, a plant based chewy sheet dog chew is created with a meat-free meat analogue member being wrapped into a plant based chewy sheet with a portion of the meat analogue member preferably protruding at a seam of the plant based sheet piece. Preferably there are a plurality of meat analogues wrapped in the plant based chewy sheet.

In another aspect of the present invention, an edible pet chew is provided incorporating a plant based chewy sheet member and a meat-free meat analogue member, where the two members are placed against each other into a composite assembly with the first member and the second forming alternating layers of finished product in the composite assembly.

In another aspect of the present invention, a pet treat is provided incorporating a meat-free natural plant member and a meat-free meat analogue member, where the meat analogue member wraps about the meat-free natural plant member.

In yet another aspect of the present invention, an edible pet chew is provided incorporating a plant based extruded or injection-formed chewy piece member and a meat-free meat analogue member, where the meat analogue member wraps about the chewy piece member.

In one aspect of the present invention, it provides a preferred process for forming an edible pet chew with a meat analogue member and a chewy sheet member.

These and other objectives, features, and advantages of the present invention will become apparent from the following detailed description, the accompanying drawings, and the appended claims.

### BRIEF DESCRIPTION OF THE DRAWINGS

The objects, features and advantages of the present invention will be apparent from the following detailed descriptions of the various aspects of the invention in conjunction with reference to the following drawings, where:

FIG. 1 is a top plan view of a meat analogue member made of a plant based meat-free material imitating appearance (such as surface texture) and internal fibrous texture of dried meat, in preparation of being applied to form an edible pet chew according to an embodiment of the present invention.

FIG. 2 is a top plan view of a meat analogue member in sheet form, being formed from a plant based meat-free material imitating appearance (such as surface texture) and internal fibrous texture of sliced dried meat jerky strip, in preparation of being applied to form an edible pet chew according to an embodiment of the present invention.

FIG. 3 is a top plan view of a meat analogue member in tiny-chunk (or bit) form, being formed from plant based meat-free material imitating appearance (such as surface texture) and internal fibrous texture of tiny-chunks of traditional whole muscle jerky, in preparation of being applied to form an edible pet chew according to an embodiment of the present invention.

FIG. 4 is a top perspective view of two kinds of meat analogue members, being made of plant based meat-free material imitating appearance and texture of ground-and-formed meat jerky, where the top item is imitating ground-and-formed jerky with bumpy/uneven texture and the bottom one mimicking ground-and-formed jerky with relatively smoother surface texture.

FIG. 5 is a top plan view of a traditional whole muscle chicken jerky according to a Prior Art.

FIG. 6 is an anatomical drawing for skeletal muscle according to a Prior Art, skeletal muscle of a livestock or poultry indicating its internal fibrous structure.

FIG. 7 is an anatomical drawing for chicken muscle according to a Prior Art, indicating its internal fibrous tissue structure.

FIG. 8 is a top plan view of an edible pet chew according to an embodiment of the present invention, a rawhide chew in knotted bone configuration with meat-free plant based meat analogue member wrapped therein, where the meat analogue member imitates the appearance and texture of traditional whole muscle jerky.

FIG. 9 is a top plan view of an edible pet chew according to an embodiment of the present invention, a rawhide chew in pressed bone configuration with TVP meat analogue member wrapped in. The TVP member imitates traditional dried meat jerky.

FIG. 10 is a top plan view of an edible pet chew according to an embodiment of the present invention, a ball-shaped rawhide chew combining rawhide sheets and plant based meat analogue sheets in a form of composite assembly with rawhide sheets and meat analogue sheets forming alternating layers of the chew product, where, alternatively, a piece of additional real meat jerky may be included as well into the composite assembly, where the meat analogue sheet members imitate traditional whole muscle jerky.

FIG. 11 is a top plan view of an edible pet chew according to an embodiment of the present invention, a ball-shaped rawhide chew combining rawhide sheets and plant based meat analogue sheets in a form of composite assembly with rawhide sheets and meat analogue sheets forming alternating layers, where the meat analogue sheet members imitate ground-and-formed jerky with relatively smoother bumpy/uneven surface texture.

FIG. 12 is a top plan view of an edible pet chew according to an embodiment of the present invention, a twisted-stick-shaped rawhide chew with a plant based meat analogue member wrapping about the rawhide stick, where the meat analogue member imitates dried meat.

FIG. 13 is a top plan view of an edible pet chew according to an embodiment of the present invention, a rawhide munchy product formed from animal hide bits, meat-free plant based meat analogue bits (tiny chunks) and binder material.

FIG. 14 is a cross sectional view of the edible pet chew of FIG. 13.

FIG. 15 is a top plan view of an edible pet chew according to an embodiment of the present invention, a plant based chewy sheet chew in knotted bone configuration with meat-free plant based meat analogue member wrapped therein, where the meat analogue member imitates the appearance and texture of sliced strips of traditional whole muscle jerky.

FIG. 16 is a top perspective view of an edible pet chew according to an embodiment of the present invention, a cylinder-roll-shaped plant based chewy sheet chew with meat-free plant based meat analogue member wrapped therein, where the meat analogue member imitates ground-and-formed jerky with relatively smoother surface texture.

FIG. 17 is a top perspective view of a pet treat of the present invention, a dried sweet potato strip with a meat-free meat analogue member wrapping about it, where the meat analogue member imitates dried meat strips.

FIG. 18 is a top perspective view of an edible pet chew according to an embodiment of the present invention and a cross section view of it, a knotted-bone-shaped plant based extruded chewy piece pet chew with a meat-free plant based meat analogue member wrapping about the plant based chewy piece, where the meat analogue member imitates dried meat jerky.

FIG. 19 is a top perspective view of an edible pet chew according to an embodiment of the present invention, a bone shaped plant based injection-processed piece chew with a meat-free plant based meat analogue member wrapping about it, where the meat analogue member imitates dried meat jerky strips.

FIG. 20 is a top perspective view of an edible pet chew according to an embodiment of the present invention, a plant based chewy sheet pet chew in knotted bone configuration with a plant based chewy sheet member and a meat-free plant based meat analogue sheet member wrapping about the chewy sheet member.

FIG. 21 is a top perspective view of an edible pet chew according to an embodiment of the present invention and a cross section view thereof, a knotted-bone-shaped plant based extruded chewy piece pet chew with a meat-free plant based meat analogue strip member, where the meat analogue member imitates ground-and-formed jerky.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

It should be noted that the term “traditional rawhide” sheet in the present invention is a most popular material to form dog chews in the pet industry, referring to the by-products obtained from the slaughter of animals (especially hoofed animals such as bovine, swine, cattle, cow, water buffalo, pig, sheep, goats, marsupial, deer and elk). The hide is not exposed to tanning process and generally fur, meat and fat is removed. The dry material of traditional rawhide is mainly made of fibrous proteins, collagen, keratin, elastin and reticulin and water. To form a traditional rawhide, most of visible meat and fat may be removed; it may then be treated by soaking into calcium carbonate or calcium hydroxide solutions with ammonium salts and remnant hair may be removed; hide is split to top grain part and bottom split part, where the bottom part is selected for further processing; it may then be rinsed a few times with processes of degreasing and desulphurization; it may finally be bleached and “traditional rawhide” in sheet form is now ready for future employment. Regarding the hide splitting procedure abovementioned, the top grain close to skin surface is generally tanned and formed into leather products. The bottom portion of the hide is generally kept in its natural “raw” state without tanning. Hide in such natural, untanned state, is generally referred to as “traditional rawhide”. One common use for traditional rawhide is the production of chemicals such as capsule, gelatin and sausage casing. Another major use for traditional rawhide is to manufacture edible chew toys for dogs.

The term of “rawhide” in the present invention may include the above-described “Traditional Rawhide Sheet” and other “Formed or Reconstituted Rawhide Sheet”, where the latter is made of comminuted/ground rawhide or split/defibered rawhide fibers by re-forming back into a sheet form (sheet reforming processing method includes, but not limited to, extruding ground rawhide composition with heat to a rawhide sheet form, or defibering collagen fibers then having them reconstituted into rawhide sheet form, etc). The “Formed Rawhide Sheet” may also be called ground-and-formed rawhide. But preferably, the rawhide in the present invention is “Traditional Rawhide Sheet” which has much better chewing longevity than ground-and-formed rawhide, and additionally the latter suffers with other drawbacks. Ground-and-formed rawhide has at least the following drawbacks: A). As aforementioned, it is weak with chew longevity. B). It employs leftovers or scraps from traditional rawhide product productions which is subject to get contaminated with unfavorable foreign matters harmful to dog health. C). Sheet-forming process may involve a heat gelatinization process whose inherent fiber structure is destroyed completely; however inherent fiber structure is thought to provide excellent texture helping the removal of tooth tartar during dog chewing activity. D). To facilitate sheet-forming process such as extrusion, additional additives may be introduced to the ground rawhide creating a composition material, which may result in a product being thought unhealthy to dogs. E). Not as easy as Traditional Rawhide Sheet to acquire since it involves additional raw material (rawhide scrap) collecting and sheet-forming process. Especially when demand gets huge, it is subject to face dilemma to accommodate the demand.

It should be noted that “Textured Vegetable Protein” (abbr. TVP) generally refers to a kind of food products/components made from edible plant protein sources and characterized by having fibrous or meat-like structure. Typically, it has a wrinkled surfaced as meat jerky does. The fibrous structure may resemble whole muscle meat jerky. Typically, a TVP may have internal fiber-like structure visually similar to that of dried traditional whole muscle meat jerky and the fiber-like structure includes manually separable meat-jerky-like aligned fibers resembling traditional whole muscle meat jerky. Soy proteins are the most commonly used base materials for textured vegetable proteins, however, pea, corn, cereals, wheat, peanut, sunflower seeds, cottonseed and similar proteins can be texturized as well. Alternatively, the TVP may be in a chunk form or sheet form. Two common methods to process textured protein are thermoplastic extrusion and fiber pinning.

Extrusion is widely used to achieve this restructuring of protein-based raw material to process a variety of textured vegetable protein. Extrusion is a thermo-mechanical process by which moistened, expandable, starchy, and proteinaceous food materials are plasticized and pushed through a die by a combination of pressure, heat, and mechanical shear. During the extrusion process, mechanical and thermal energy are applied to the proteinaceous raw material, which makes the macro-molecules in the raw material lose their native, organized structure and form a continuous, viscoelastic mass. The extruder barrel, screws and dies align the molecules in the direction of flow. This realignment “exposes bonding sites which lead to cross-linking and reformed, expandable structure” that creates the fibrous texture.

It should be noted that the term “meat analogue” in the present invention refers to a plant based (particularly plant protein based) pet food product/component that approximates or imitates or approaches certain aesthetic qualities/characteristics/properties/features (such as appearance, surface texture appearance, surface wrinkled texture appearance and internal texture characteristics) and/or chemical characteristics (such as protein factor and nutrition) of a certain type of dried meat, while, at the same time, being meat-free or containing only minor amount of meat ingredient. The dried meat being imitated may include traditional whole muscle meat jerky and ground-and-formed jerky, where whole muscle jerky imitation is preferred since it retains visually obviously much more natural meat characteristics, such as distinct fibrous tissue texture, appealing to consumers (distinct fibrous tissue texture provides strong visual impact to dog owners and dogs forming a critical buying urge or gnawing urge to them; and fibrous structure material can better remove tartar from dog teeth than non-fiber ones). Alternatively, the meat analogue may be in a chunk form or sheet form. Preferably, the meat analogue is in a sheet or slice-like form, with an intention to make an easy composite assemble when it works with other sheet-form components, such as rawhide sheet and plant based extruded chewy sheet. Preferably, the meat analogue is made of textured vegetable protein (TVP) material, textured pea protein or textured soy protein (TSP). Preferably, the meat analogue member is in a form of distinct chunks/pieces/sheets/slice, having manually separable meat-like aligned fibers resembling a piece of dried natural meat in appearance and texture. Preferably, the meat analogue is free of meat ingredient. The reasons why “meat free” is preferred include: For meat analogue, as a meat substitute/replacement, “meat free” meat analogue offers a complete substitution; “Meat free” enables the meat analogue to completely avoid the aforementioned drawbacks A-G of meat products; “Meat free” meat analogue delivers a distinct image to consumers on what it is, which may create distinct strong selling points for the chew product; “Meat free” may identify the products with this meat analogue member from other competes with meat content, for example being labeled as “meat free dog chews”. Preferably, the meat analogue is free of meat by-products ingredient. It may alternatively be animal hide free. Even further, it may be, but not necessarily, animal ingredient free in the concerns of vegetarians or vegans. Preferably, the meat analogue is a plant protein based one since natural meat is a protein based or protein rich material. Protein nutrition is a primary nutrition element that natural meat provides and plant protein material can well replace it accommodating the specific nutrition needs. Additionally, it is typically much more difficult to make low protein materials resembling jerky products creating a big challenge to the pet treat manufacturer to accomplish the jerky imitation jobs, however, a plant protein based material facilitate the jobs. Preferably the meat analogue is high in protein: for example, it has over 10% protein by weight on an as fed basis; more typically, the meat analogue has at least 22% protein by weight on an as fed basis. Alternatively, the meat analogue product is produced and extruded under high shear conditions to provide a product having a plurality of striated and separable aligned fibers and a dried real meat appearance. Preferably, the meat analogue has a surface fibrous structure texture or a surface winkle-like texture visually resembling/similar to dried meat. Preferably, the meat analogue has an internal fiber-like structure visually resembling/similar to dried meat. Typically, the average diameter of the fibers in the internal structure is in a approximate range between 0.1 mm to 5 mm. Preferably the meat analogue is gluten free since gluten materials are considered by experts in this industry as the ones that could potentially make dogs allergic. Examples of gluten-free plant material are tapioca, soybean, pea, sweet potato, potato and carrot. Preferably, the meat analogue is a dried treat member with moisture content ranging from 6% to 20%. Considering plant based material lacking of or being inadequate of some necessary nutrient elements that meat offers instead, preferably, the plant based meat analogue is thus nutrition enhanced by adding additional nutrient element(s) to its formula as certain dietary supplements such as minerals, vitamins, carbohydrates and dietary fibers. But, alternatively, in some embodiments (although these embodiments may not be preferred ones), meat ingredients, such as ground chicken and pork emulsion, may appear in the formula of the meat analogue in addition to plant materials in a purpose of such as flavor enhancing and nutrition concerns. However, the percentage of meat ingredients in the meat analogue is preferably low or in minor amount (preferably less than 35% by weight, more typically less than 10% by weight) in order not to violate the initial intention of creating this meat analogue/substitute under the awareness of the aforementioned drawbacks A-G of meat products. The meat analogue may also be called meat substitute, meat alternative, faux meat, mock meat, imitation meat and meat replacement.

As aforementioned, the meat analogue of the present invention preferably has at least 22% protein by weight on an as fed basis. The reasons why it is preferred to be with “at least 22%” protein content may include: A). Dried meat that the meat analogue is intended to imitate is a “high protein” products. Thus preferably, the meat analogue is a “high protein” one as well, facilitating the imitation. B). In some regulations 22% is approximately the threshold for a pet treat product labeled as “high protein”.

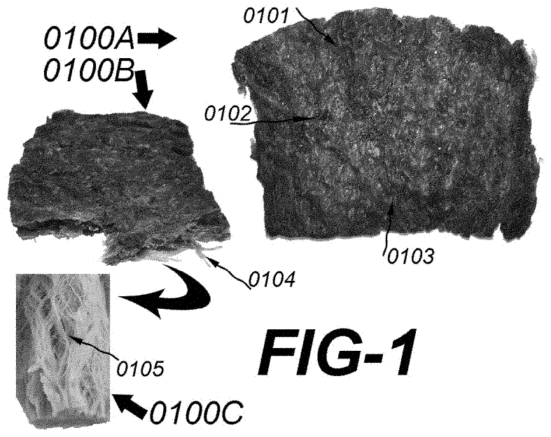

Now referring to FIG. 1, a meat analogue member according to an embodiment of the present invention is illustrated. Member 0100A illustrates a piece of meat analogue member, member 0100B illustrates the same one with a broken edge of the meat analogue member 0100A, and view 0100C illustrates the interior view of the meat analogue member 0100A/0100B. The meat analogue member 0100A is made of or formed of a plant protein based material (preferably meat-free and preferably it is a textured vegetable protein TVP) imitating surface texture appearance and internal fibrous texture of traditional whole muscle jerky. The surface area examples that arrows 0101/0102/0103 point out indicate fiber-like textures or wrinkle-like or wrinkled textures. The area 0104 is a breakage part of the meat analogue member 0100B having its internal structure exposed, which makes its internal fibrous tissue structure visible, a kind of manually separable aligned fibers. Arrow 0105 points at the internal fiber structure of the meat analogue member internal view 0100C. The “textured vegetable protein” material may be sourced from Westpoint Naturals from U.S.A with SKU No. 50745.

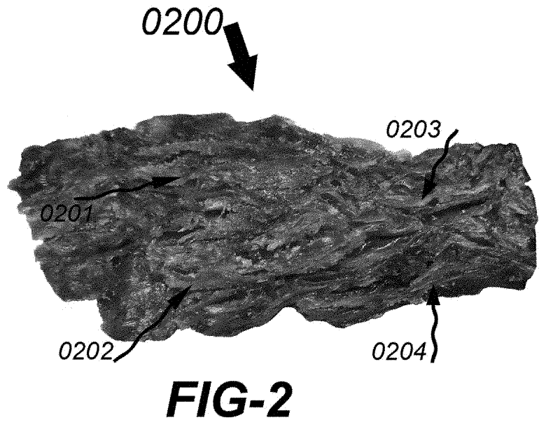

As shown in FIG. 2, a meat analogue member according to an embodiment of the present invention is illustrated. Meat analogue member 0200 in a sheet form is made of a plant based meat-free meat analogue material imitating surface wrinkled texture appearance and internal fibrous structure texture of a thin sliced dried meat jerky strip. The meat analogue member 0200 may be formed by slicing the meat analogue piece 0100A of FIG. 1, as a meat analogue slice, where some surface area of the meat analogue member 0200 may indicate split fibers created by slicing the fibers from the meat analogue member 0100A. The surface area examples that arrows 0201/0202/0203/0204 point out indicate surface fiber-like or wrinkle-like textures, creating a wrinkled surface.

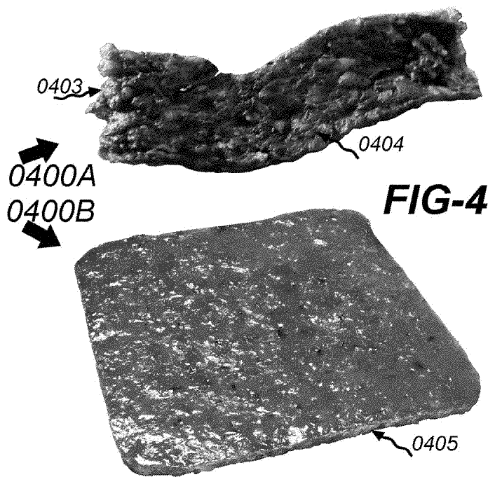

Now regarding meat analogue imitating ground-and-formed dried meat jerky. Please refer to FIG. 4, two types of meat analogues 0400A/0400B made of plant based meat-free material imitating appearance and texture of ground-and-formed meat jerky. Meat analogue 0400A is imitating ground-and-formed jerky with bumpy/uneven or wrinkle-like texture and meat analogue 0400B mimics ground-and-formed jerky with relatively smoother surface bumpy/uneven texture. Textures 0403/0404 indicate a surface texture with visually apparent ground meat-like structure. Texture 0405, appearing in a side of the meat analogue 0400B, looks like a piece of ground-and-formed meat jerky with meat muscle having been very finely ground.

It should be noted that the term “plant” in the present invention generally refers to the material selected from, but not limited to, the group consisting of: a plant material, a plant derived material, a plant protein, a plant starch, a vegetable material, a vegetable derived material, a vegetable protein and a vegetable starch. Typically, the “plant” includes a protein rich plant such as pea, soybean, peanut, almond, mushroom, legumes, beans, grains, chia, algae, seaweed, spirulina, cereals (such as barley, rye, rice, corn and wheat) and nuts.

It should be noted that the term “plant based” is defined as a material/component that has at least 35% plant ingredient by weight on an as fed basis. Preferably, the material has at least 50% plant ingredient by weight on an as fed basis. Preferably, the plant ingredient is the number one ingredient by weight on an as fed basis, which is larger than any other individual ingredient in the material, such as glycerin, chicken, chicken liver and sorbitol.

It should be noted that the term “plant protein based” is defined as a material/component that has at least 14% plant protein material on a dry matter basis by weight or at least 12% plant protein material by weight on an as fed basis. Preferably, the material/component has at least 20% plant protein material by weight on a dry matter basis (equal to approximately at least 18% plant protein material by weight on an as fed basis). Preferably, plant protein is the number one material by weight on an as fed basis in the composition material which is larger than any other individual ingredient, such as vegetable starch, glycerin and chicken liver, in the “plant protein based material” composition material. As remarks, the aforementioned at least 12% plant protein material by weight on an as fed basis existing in the “plant protein based material” may result in a “plant protein material” with approximately 12% crude protein content by Kjeldahl Determination method (preferably protein factor of 6.25 is applied in the method). And the aforementioned at least 18% plant protein material by weight on an as fed basis existing in the “plant protein based material” may result in a “plant protein material” with approximately 18% crude protein content by Kjeldahl Determination method (preferably protein factor of 6.25 is applied in the method). According to some tests conducted by the inventor of the present invention intended to produce a meat analogue product with fibrous structure texture, a plant based composition material with plant protein ingredient was applied. It shows that plant protein ingredient may be a key one to form the plant based composition to produce a meat analogue product. They may indicate that, 12% plant protein material by weight on an as fed basis appearing in the meat analogue product may be the least proportion that may create surface texture (such as a wrinkled surface texture) to the meat analogue product, where the surface texture resembles that of dried meat. And they may also indicate that, 18% plant protein material by weight on an as fed basis appearing in the meat analogue product may be the least proportion that may create visible fibrous structure texture (particularly a visible internal fibrous structure texture) to the meat analogue product, where the fibrous structure texture may resemble that of a traditional whole muscle meat jerky.

It should be noted that the term “meat” in the present invention refers to the clean flesh derived from slaughtered animals (including but not limited to mammals, livestock, bovine, swine, cattle, pig, poultry, chicken, duck, turkey and fish) and is limited to that part of the striate muscle which is skeletal or that part which is found in the tongue, in the diaphragm, in the heart or in the esophagus. In other words, “meat” is primarily the muscle tissue of an animal.

It should be noted that the term “tiny chucks” or “bits” in the present invention refers to a small piece material with visually small sizes. Generally, the size of the material pieces is approximately between 0.04 mm² to 400 mm². More typically the size of the material pieces is between 0.25 mm² to 100 mm².

It should be noted that the term “jerky” generally refers to a lean trimmed meat that has been cut into strips and then dried (dehydrated) to prevent spoilage, or that has been ground, formed into a composition material by mixing with additional ingredients, such as vegetable starch, vegetable protein, sorbitol, sugar, salt and preservative, formed into a sheet form and then dried (dehydrated) to prevent spoilage. It may include traditional sliced whole muscle meat jerky and ground-and-formed jerky.

The term “dried” means a processing method to have a material reduced with moisture by for example solar dry, freeze dry and heating.

The term “dried meat” refers to a meat product that is dried (dehydrated) with its moisture partially removed. It primarily refers to traditional whole muscle meat jerky and ground-and-formed jerky.

It should be noted that the term “rawhide munchy product” generally refers to a certain dog chew composite product mainly, primarily or substantially formed of rawhide (animal hide) bits and a binder ingredient, such as cooked glutinous rice flour paste, holding the animal hide bits together firmly. Generally, the rawhide munchy product includes at least 50% rawhide bits by weight in the composite. Generally, the rawhide munchy product chewing function is substantially or primarily provided by the animal hide bits and binder material. Typically, the munchy product is formed by extrusion, molding or pressing process.

It should be noted that the term “dried natural plant piece member” refers to a product member substantially made of a chunk of plant piece which is dried. Preferably, the plant piece is substantially in its inherent form/structure after its being separated from its main part. For example, a piece of apple (to make an apple chip) is cut from a whole apple and the piece of apple will not experience a process, such as grinding to significantly change its inherent form. Alternatively, the plant piece may be further treated by adding some additives, such as colorant, flavor and preservative. Some preferred dried natural plant piece may be sweet potato chunk, sweet potato slice, banana chip, apple chunk, apple slice, carrot chunk, carrot chip, tapioca chunk, tapioca chip, potato chunk and potato chip.

It should be noted that the term “assemble” means to fit together all separate parts/members/components of a pet chew/treat product. For example, the separate components are manipulated (such as knotting, wrapping, rolling, folding and twisting) by hand or extrusion/injection/molded/rolling process by machine to have the components together form a pet chew product.

A typical natural dried meat product (mainly referring to meat jerky, including traditional whole muscle jerky and ground-and-formed jerky) has its essential typical qualities/features/properties/characteristics as follows (from A to K):

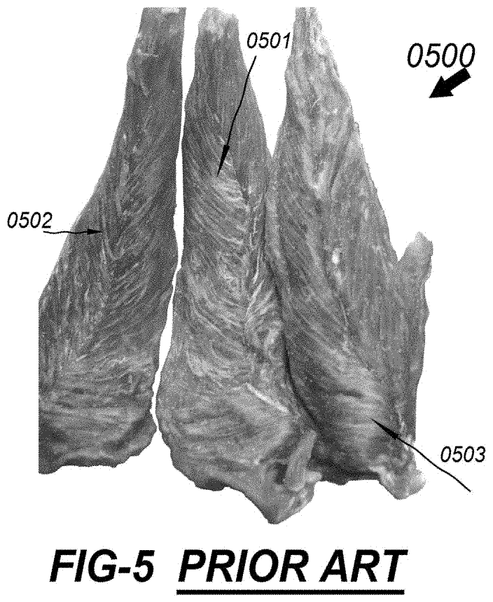

(A) Appearance. Appearance may include coloring, surface texture and shape. Particularly in the aspect of surface texture, surface texture feature is generally an essential feature that critically has a consumer identify it as a meat jerky. The surface texture typically refers to a fibrous structure and/or a wrinkle-like texture, and/or a bumpy/uneven texture appearing on the surface (more typically the fibrous structure and wrinkle-like texture). Seemingly, internal fibrous structure of jerky extends to the surface creating the surface with fibrous structure and/or a wrinkle-like texture. Now referring to FIG. 5 (prior art), a natural chicken jerky product 0500 takes portions 0501, 0502 and 0503 as visible fibrous or wrinkled surface texture and the whole jerky bears bumpy/uneven surfaces. Even after meat jerky is sliced to thin jerky strips, the jerky strips still bear the typical surface texture although it weakens.

(B) Protein content. Discounting natural water content in dried meat product, dried meat is mainly formed of protein as an inherent quality.

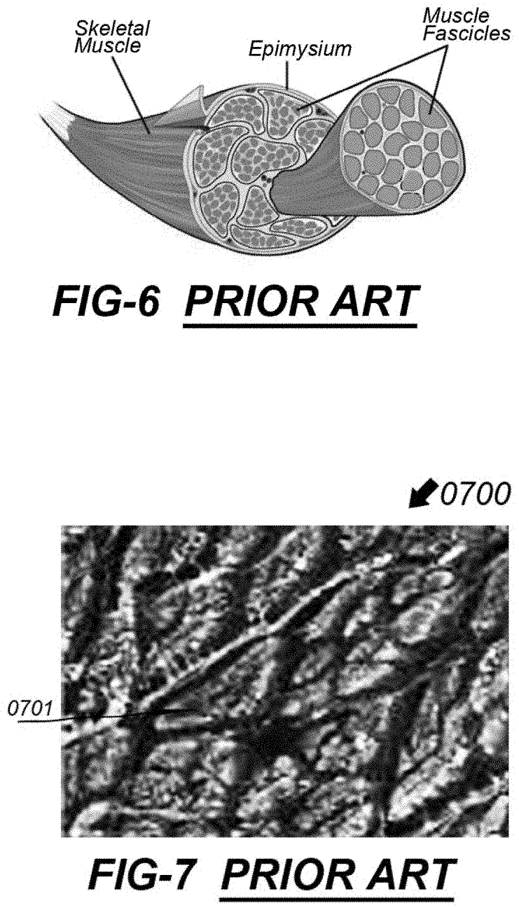

(C) Texture, including surface and internal one. Surface texture is already covered in above point A. Jerky internal “fibrous tissue texture” is naturally created by muscle inherent structures, having manually separable aligned fibers therein. Taking skeletal muscle as an instance, referring to FIG. 6 (prior art), it is mainly formed of muscle fascicles, where the fiber-like fascicle structure forms the internal fibrous tissue structure of meat. Also 0701 of FIG. 7 (prior art), a cross sectional image of a muscle, refers to a type of muscle fiber.

(D) Smell/Scent/Odor. Dried meat smell is derived from the characteristic inherent smell of flesh.

(E) Taste/Flavor. Dried meat taste is derived from the characteristic inherent taste of flesh.

(F) Nutritional value. It may include protein, minerals, vitamins, carbohydrates and dietary fibers as its inherent nutrition quality.

It should be noted that, a meat analogue product in pet industry must necessarily bear at least one quality/feature/property/characteristic of the qualities A-F as described above (especially A, B and C), OR, the product is viewed as a failure to imitate dried meat product. Seemingly for the imitation requirements, quality A/B/C may be relatively more important than D/E/F because the success or failure of imitation practice is primarily decided by dog owner who buys and feed it rather than dog who eats it. Seemingly, compared to dogs (who decide to gnaw or not to gnaw), dog owners (who decide to buy or not to buy) are more concerns on quality A/B/C than D/E/F when they get interested in a meat analogue product.

Plant Based Meat Analogue product (or product member) of the present invention imitating dried meat is now being disclosed to serve as an alternative to natural dried meat aforementioned, imitating some necessary qualities/properties or features, such as appearance and texture, of dried meat. Meat analogue is distinguished from dried meat product, which is typically an extruded/molded/injection product made of a composition material with plant protein based ingredients.

Advantages of introducing meat analogue components to replace dried meat ones at least include: A). Environment friendly. Versus livestock/poultry raising industry, plant farming industry doesn't release green house gases. It takes much less water to generate same amount of protein than the former. B). Safe to dog's health. Plant farming and plant protein industry doesn't utilize any antibiotics. C). Safe to dog's health with regard to cholesterol. It's free of cholesterol. And it is healthier with comparatively lower fat content or even free of fat. D). Doesn't cause certain heart disease/cancer that meat potentially does. E). Fresher breath. F). Easier digestion and a release to dog's stomach. G). Relatively economical. H). No risk of salmonella contamination, safe to dogs.

In some embodiments of the present invention, an edible pet chew incorporates/combines a plant based meat analogue member and a chewy sheet member. It overcomes the drawbacks of a product formed solely of a meat analogue or solely of chewy sheet as aforementioned. Alternatively, the chewy sheet member is an animal hide sheet or a plant based chewy sheet. But preferably, the chewy sheet member is an animal hide because animal hide bears much longer chewing longevity than other sheets such as plant based chewy sheet, lasting much longer before being digested. And, hide is a high protein product with over 80% protein content and plant based chewy sheet could be with just 5% protein. Alternatively, the edible pet chew may further have an additional member of real meat jerky or meat strips which may further enhance appealing level to dogs while being assembled with other aforementioned members. Preferably, the chewy sheet member is meat free. Preferably, the whole pet chew product is meat free.

Preferably, the pet chew is formed in a configuration that, the meat analogue member is substantially wrapped in the chewy sheet member, or, at least a portion of the meat analogue member is concealed by the chewy sheet member. Generally, the meat analogue is more palatable to dogs than the chewy sheet. Regarding the advantages of this configuration fashion, the presence of the meat analogue member can encourage dogs to chew and the dogs will eat starting with the chewy sheet before their reaching the inner meat analogue member. Dogs are attracted by the meat analogue wrapped therein but they can't reach it unless they ingest a part of the chewy sheet which conceals it. In this pattern, the pet chew achieves continuing attraction to dogs during their chewing activity. Preferably, there are a plurality of meat analogues wrapped in the chewy sheet.

Here comes an aspect of the present invention. In this aspect, the edible pet chew includes a first member of rawhide sheet member and a second member of plant based meat analogue member, where the meat analogue member and rawhide sheet member are assembled. Alternatively, the proportion of the member of “rawhide sheet” to the member of “meat analogue” assembled therein is in the approximate range between 1:5 and 30:1 by weight in finished product. Preferably the weight of the rawhide sheet accounts for at least 20% (more typically at least 50%) of the total weight of the edible pet chew product. Although being an animal ingredient, animal hide is viewed as a special one compared to other ones such as meat and meat by-products, enjoying at least the following advantages: (i) of course, it's meat-free, which may be a buying urge to consumers; (ii) very low cholesterol; (iii) inherently a perfect chew material; (iv) extremely less chance of antibiotics residue; (v) no risk of salmonella contamination. Advantages of this aspect at least include: A). Rawhide as a perfect longevity dog chew member provides essential chew function to the whole product, overcoming the drawbacks of meat analogue which is generally a weak one. B). Meat analogue is generally significantly more appealing than rawhide, overcoming the drawbacks of dog chew solely made of rawhide. C). Meat analogue provides extra nutrition/benefits/protein in addition to rawhide component. D). Meat free meat analogue provides health benefits to dogs as aforementioned compared to the products formed of a rawhide and meat jerky composite assembly. E) Meat analogue is environment friendly, fresher breath, easier digestion and relatively more economical than the products formed of rawhide and meat jerky composite assembly. F). Rawhide is naturally protein rich and meat analogue is potentially protein rich, which creates a protein rich whole product. It is worth mentioning that all prior arts are silent about an intention to introduce a new member of plant based meat analogue to a rawhide sheet chew product and have them assembled together creating a composite pet chew product. The meat analogue, being generally considered as a weak component, cannot work solely as a pet chew. The present invention surprisingly discloses a solution by having it combined with a rawhide sheet which primarily provides chew function of the composite product. Particularly, all prior arts are silent to create a pet chew with features of the following as a whole: The pet chew has a rawhide sheet member and a plant based meat analogue member; the meat analogue is plant based and free of meat ingredient; the meat analogue imitates at least the appearance and texture of dried meat jerky; the meat analogue member has internal aligned fibrous structure; a particular feature that a meat analogue is wrapped in a rawhide sheet may also be included.

Preferably, the pet chew is formed in a configuration that, the meat analogue member is substantially wrapped in the rawhide sheet member, or, at least a portion of the meat analogue member is concealed by the rawhide sheet member. As an embodiment of this aspect, a plant based meat analogue is substantially wrapped into a rawhide sheet with a portion of the meat analogue member protruding at the seam of the rawhide piece. In this configuration, the rawhide sheet may form the outer layer of the product including a longitudinal seam therein. The meat analogue member may form an inner member and be substantially retained within the outer layer. A portion of the inner member extends through the seam of the outer layer and is partially exposed outside the outer layer. Preferably there are a plurality of meat analogues wrapped in the animal hide sheet. Alternatively, the proportion of the member of rawhide outer layer to the member of meat analogue wrapped therein by weight in finished product is in the approximate range between 1:5 and 30:1. Alternatively, the edible pet chew may further have an additional member of real meat jerky or meat strips which may further enhance appealing level to dogs assembled with other aforementioned members. But preferably, the whole pet chew product is meat free under the consideration of aforementioned reasons.

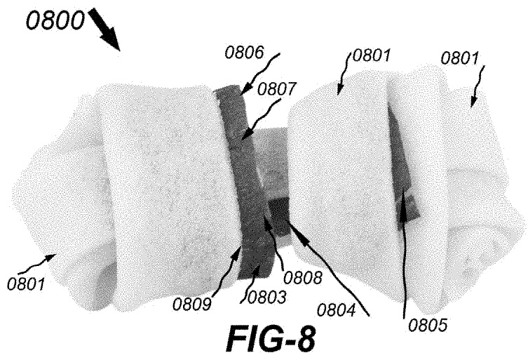

Now referring to FIG. 8, an edible pet chew according to an embodiment of the present invention is illustrated. A rawhide pet chew 0800 is formed in knotted bone configuration with meat-free plant based meat analogue members (preferably a textured vegetable protein TVP piece) wrapped therein. The rawhide sheet is folded or rolled longitudinally with the meat analogue member and is knotted at first and second longitudinal ends, where the first and second longitudinal ends have knots thereat respectively. The rawhide sheet substantially serves as the outer layer of the pet chew. Member 0801 is a rawhide sheet and Members 0803/0804/0805 are meat-free meat analogue members imitating the appearance and texture of traditional whole muscle jerky. The rawhide sheet 0801 substantially forms the outer layer of the product and the meat analogue 0803/0804/0805, the inner layers. Now referring to the meat analogue member 0803, it visually resembles a piece of meat jerky. Meat analogue member 0803 may be provided by meat analogue member 0100 (FIG. 1) or meat analogue member 0200 (FIG. 2). It has fibrous tissue structure on the surface and internal part similar to a whole muscle jerky. The surface area examples that arrows 0806/0807/0808 point out indicate fiber-like or wrinkle-like textures. Processes to make the pet chew include, get the rawhide sheet 0801 and the meat analogue 0803/0804/0805 ready. Put the meat analogues 0803/0804/0805 inside of the rawhide sheet 0801 and fold it. Tie the two longitudinal ends of the folded rawhide sheet to make a simulation of two epiphyses of a real bone with a diaphysis in the middle. The meat analogue 0803 substantially retains within the rawhide sheet 0801 partially protruding at a seam 0809 of the rawhide sheet 0801. Exposed part of the meat analogue 0803 provides an initial and appealing odor to attract dog to the product before he starts to gnaw, and provides taste and scent attraction when chew activity begins. As the dog continues to chew for extended periods of time, the outer layer of the rawhide sheet 0801 disintegrates and is digested with a portion of the meat analogue 0803 (exposed part) immediately being revealed. After it, a new portion of 0803 is exposed with its scent/odor/taste providing a fresh attractant to the dog. Continuous gnawing is encouraged until the rawhide chew is completely digested.

In some embodiments to form the meat analogue member of the present invention, the meat analogue may be formed with plant based material by a process, such as extrusion, rolling, molding, pressing, spinning, shear-induced fibrous structure formation, injection and 3D printing. In some embodiments, fibrous structure texture of the meat analogue is achieved by a process such as protein extrusion in cooker extruder under pressure, protein fiber spinning, heated-induced gel protein and shear-induced fibrous structure formation process.

Natural plant ingredients probably don't have appealing flavors that dog like, which could make a plant based meat analogue product not inherently attractive to dogs. Thus in some embodiments to form the meat analogue of the present invention, in order to introduce flavor/smell(scent, odor)/taste into the meat analogue to enhance palatability, an additional flavor ingredient may be added to the meat analogue composition recipe. The flavors include, but not limited to, dried brewer yeast, yeast extract, natural flavor, hydrolyzed vegetable protein HVP, enzyme hydrolyzed vegetable protein EVP, leghemoglobin, meat extract and an animal-derived hydrolyzed animal protein HAP. Animal-derived hydrolyzed animal protein HAP (or meat extract) generally is not viewed as a meat ingredient which is still within the scope of “meat-free”, thus it could work for a certain meat-free meat analogue recipe embodiments, but it could be not preferred. Preferably, but not necessarily, the flavor is free of animal-derived ingredient.

In yet some alternative embodiments to form the meat analogue member of the present invention, colorant/coloring, for example plant-derived colorant, such as carotenoids, betanin, caramel, chlorophyllins, Riboflavin, Curcumin and vegetable carbon black, may be applied to the meat analogue to achieve dried-meat-like color. The colorant/coloring may be meat-free.

As a formula embodiment to produce the meat analogue member of the present invention, the ingredients to form the meat analogue (particularly the meat analogue member being a TVP in this case) include Soybean isolated protein (67%), Wheat protein (10%), Soybean meal (soy oil removed, 9%), Corn starch (7.85%), Carrageenan gum (3%), Dried brewer yeast (2%), Hydrolyzed vegetable protein HVP (1%), Coloring (0.1%) and Potassium sorbate (0.05%). This formula is a plant protein based one (including over 77% plant protein, where pertinent ingredients are soybean isolated protein, wheat protein and soybean meal in this case). It is free of meat ingredient, free of meat by-products and free of animal ingredients. This formula may create a meat analogue with fibrous tissue texture structure after being formed by a certain manufacturing process, such as high temperature high pressure high shear extrusion process. As a preferred embodiment of manufacturing process for a meat analogue (TVP) with this aforementioned formula: A). Prepare composition materials in a formula as aforementioned and have them preconditioned with adjusted moisture. B). have them mixed well in a blender. C). Feed the composition material into an extruder. D). In the extruder, the composition material is treated with high temperature (such as a variation temperature of 80° C. to 190° C. in different phrases of the extruding procedure) and high pressure. Fibrous structure is generated herein. Cut to a predetermined shape, such as a rectangular shape. E). Cooling

As another formula embodiment to form the meat analogue member of the present invention, the ingredients to form the meat analogue include Soybean meal (soy oil removed, 55%), Soy protein concentrate (20%), Wheat protein (9%), Wheat flour (4%), Glycerin (8%), Dried brewer yeast (2%), Hydrolyzed poultry protein (1%), Coloring (0.95%) and Potassium sorbate (0.05%). This formula is a plant protein based one (including over 50% plant protein, where pertinent ingredients are soybean meal, soy protein concentrate, wheat protein and wheat flour in this case). It is still viewed as free of meat ingredient, free of meat by-products although a hydrolyzed poultry protein of an animal derived ingredient is applied.

As another formula embodiment to produce the meat analogue member of the present invention, the ingredients to form the meat analogue include Pea meal (pea oil removed, 55%), Pea isolated protein (33%), Glycerin (8%), Dried brewer yeast (2%), Hydrolyzed poultry protein (1%), Coloring (0.95%) and Potassium sorbate (0.05%). This formula is a plant protein based one (including over 50% plant protein, where pertinent ingredients are pea meal and pea isolated protein in this case). It is gluten free. It is still viewed as free of meat ingredient, free of meat by-products although a hydrolyzed poultry protein of animal derived ingredient is applied.

As another formula embodiment to produce the meat analogue member of the present invention, the ingredients to form the meat analogue include Soybean meal (soy oil removed, 93%), Vegetable oil (3%), Dried brewer yeast (2%, a flavor and taste enhancer), leghemoglobin (1%, a flavor), Coloring (0.95%) and Potassium sorbate (0.05%). This formula is a plant protein based one (including over 60% plant protein, where pertinent ingredients is soybean meal in this case). It is free of meat ingredient, free of meat by-products and free of animal ingredients.

As another formula embodiment to form the meat analogue member of the present invention, the ingredients to form the meat analogue include Rice flour (70.8%, classified as plant ingredient), Vegetable glycerin (8%), Gelatin (7%, classified as animal ingredient but meat free), Bacon/Pork (5%, classified as meat ingredient), Cellulose powder (2%, classified as plant ingredient), Calcium carbonate (2%), Sweet potato (2%, classified as plant ingredient), Lecithin (1%), Carrageenan gum (1%), Hydrolyzed meat protein (0.5% classified as animal derived ingredient), Brewer yeast (0.5%) and Coloring (0.2%). This formula is a plant based one (including 70.8% rice flour and 2% cellulose powder in this case). But this formula is not meat free since it includes bacon/pork in it. The bacon/pork can be replaced by other meat materials, such as chicken, duck, beef, etc. As being aforementioned, in the case that meat ingredient is applied in a formula to form the meat analogue, it is preferred to be in a limited percentage or minor amount (this formula containing only 5%). A preferred embodiment of manufacturing process for a meat analogue with this aforementioned formula is injection or molding.

As another formula embodiment to produce the meat analogue member of the present invention, the ingredients to form the meat analogue include Soybean isolated protein (80%), Vegetable oil (10%), Vegetable Glycerin (5%), Dried Brewer Yeast (2%), Maltodextrin (1%), Hydrolyzed vegetable protein HVP (1%), Gum arabic (0.5%), Salt (0.2%), Succinic acid (0.1%), Acetic acid (0.08%), Tapioca starch (0.05%), Cellulose (0.03%), Methylcellulose (0.02%) and Ascorbic acid (0.02%). And additionally, some nutrient element ingredients may be added into this formula including Mixed tocopherols (Vitamin E), Zinc Gluconate (minerals), Ferrous lactate (minerals), Thiamine hydrochloride (Vitamin B1), Sodium ascorbate (Vitamin C), Niacin (Vitamin B3), Pyridoxine hydrochloride (Vitamin B6), Riboflavin (Vitamin B2) and Vitamin B12. This formula is a plant protein based one (including about 80% plant protein, where pertinent ingredients is soybean isolated protein in this case). It is free of meat ingredient, free of meat by-products and free of animal ingredients. And it is gluten free.

As another formula embodiment to form the meat analogue member of the present invention, the ingredients to form the meat analogue include Isolated pea protein (91%), Vegetable oil (5%), Dried brewer yeast (2%), Potato protein (1.53%), Methylcellulose (0.2%), Yeast extract (0.07%), Dextrose (0.05%), Potato starch (0.05%), Soy leghemoglobin (0.05%) and Salt (0.05%). This formula is a plant protein based one (including about 92% plant protein, where pertinent ingredients is isolated pea protein and potato protein in this case). It is free of meat ingredient, free of meat by-products and free of animal ingredients. And it is gluten free.

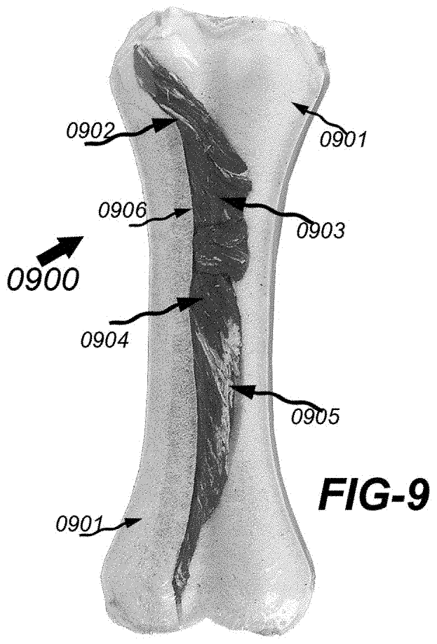

Now referring to FIG. 9, another edible pet chew according to an embodiment of the present invention is illustrated. A rawhide chew 0900 in pressed bone configuration with textured vegetable protein TVP (plant protein based meat analogue) member wrapped in is formed. The TVP member imitates traditional dried meat jerky. Member 0901 is a rawhide sheet and Member 0904 is a TVP member. Now referring to the TVP member (meat analogue member) 0904, it visually resembles dried meat jerky with surface texture resembling that of a piece of jerky. It has fibrous tissue structure on the surface and preferably in internal part as well similar to whole muscle jerky. The surface area examples that arrows 0902/0903 point out indicate fiber-like or wrinkle-like textures. 0905 shows a breakage area of the meat analogue where internal fibrous structure becomes visible. The TVP member can be produced by extrusion process under high pressure high temperature high shear conditions to provide a product having a plurality of striated and separable aligned fibers and a real meat appearance.

It is worth mentioning that all prior arts are silent about an intention to apply a plant based meat analogue member to a rawhide sheet chew product creating a composite pet chew product, where the meat analogue member is substantially wrapped in the rawhide sheet member with at least a portion of the meat analogue member being concealed by the rawhide sheet member. The meat analogue is more palatable to dogs than the hide. The presence of the meat analogue member being wrapped in can encourage dogs to chew and the dogs will eat starting with the animal hide before their reaching the inner meat analogue member. Dogs are attracted by the meat analogue wrapped therein but they can't reach it unless they ingest hide which conceals it. In this pattern, the pet chew achieves continuing attraction to dogs during their chewing time. On the other hand, meat analogue, being generally considered as a weak/soft component, cannot work solely as a pet chew. The present invention surprisingly discloses a solution by having it wrapped into a rawhide sheet which mainly provides chew function of the composite product. The rawhide sheet prevents the meat analogue from being reached easily by dogs and from being gnawed easily. This new product requires surprising invention, where a skilled person with ordinary skills in this art cannot disclose it. Particularly, all prior arts are silent to create a pet chew with features A/B/C of the following as a whole (including but not limited to): A.) The pet chew has a rawhide SHEET member and a plant based meat analogue member, where the meat analogue member is substantially wrapped in the rawhide sheet. B.) The meat analogue is plant based and free of meat ingredient. This may create a whole meat-free edible pet chew product enjoying strong selling points of “meat free” which provides certain benefits as aforementioned regarding meat replacement and enjoying appealing package claims of “meat free”. It is meat free but simultaneously still remains appealing to dog owners and dogs as meat does. C.) The meat analogue imitates at least the appearance (particularly the surface texture appearance) and texture of dried meat jerky. And further, they are silent about a meat analogue member having internal fibrous structure as whole muscle jerky does. Also, they are silent about a textured vegetable protein (TVP) member wrapped therein.

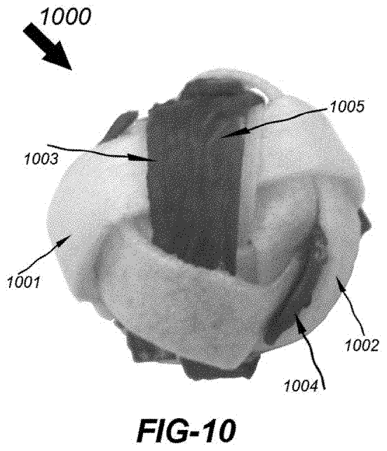

In some embodiments of this aspect, a first member of a rawhide sheet and a second member of plant based meat analogue are placed against each other into a composite assembly with the first member and the second forming alternating layers of finished product in the composite assembly. Now referring to FIG. 10, another edible pet chew according to an embodiment of the present invention is illustrated, a ball-shaped rawhide chew 1000 combining rawhide sheets, such as rawhide sheet 1001/1002, and plant based meat analogue sheets, such as the meat analogue sheet 1003/1004, in a form of composite assembly with rawhide sheets and meat analogue sheets forming alternating layers. Meat analogue member 1003/1004 may be provided by meat analogue member 0200 as illustrated in FIG. 2. The meat analogue sheet members imitate traditional dried meat jerky. The product has a plurality of rawhide sheets and meat analogue sheets. The surface area example that arrow 1005 points out indicates fiber-like or wrinkled textures. Alternatively, sheet member 1004 is a piece of real dried meat jerky instead of a meat analogue providing enhanced appealing to dogs.

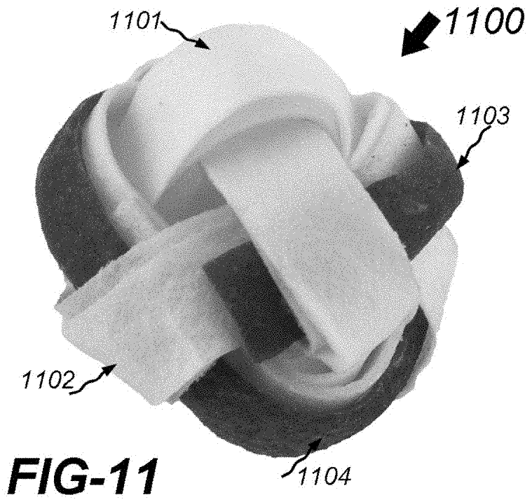

As shown in FIG. 11, another edible pet chew according to an embodiment of the present invention is illustrated, a ball-shaped rawhide chew 1100 combining a plurality of rawhide sheets, such as rawhide sheet 1101/1102, and a plurality of plant based meat analogue sheets, such as meat analogue sheet 1103/1104, in a form of composite assembly with the rawhide sheets and the meat analogue sheets forming alternating layers. The meat analogue sheet members imitate ground-and-formed meat jerky (similar to the meat analogue 0400B as shown in FIG. 4) which takes relatively smoother surface texture than the ones imitating traditional whole muscle jerky. The surface texture of the meat analogue sheets 1103/1104 resemble that of a ground-and-formed jerky.

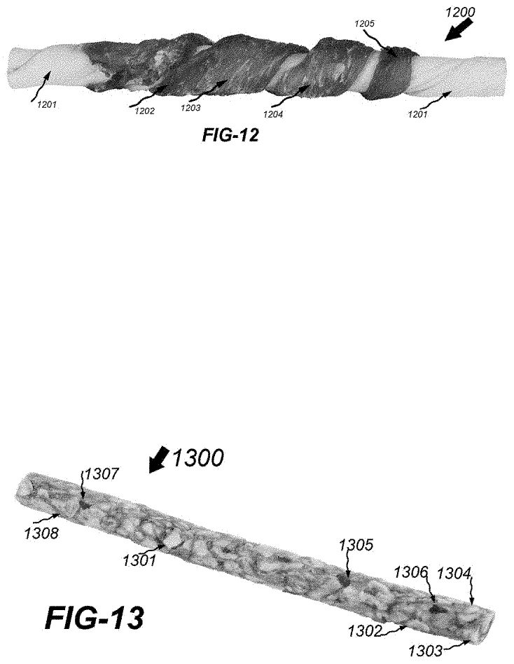

In some other embodiments of this aspect, a pet treat is provided incorporating/combining a rawhide sheet member and a meat-free meat analogue member, where the meat-free meat analogue member wraps about the rawhide sheet member. Now referring to FIG. 12, another edible pet chew according to an embodiment of the present invention is illustrated, a twisted stick-shaped rawhide chew 1200 with a plant based meat analogue member 1202 wrapping about the rawhide stick 1201. The meat analogue member 1202, a long strip, imitates dried meat. Meat analogue member 1202 may be provided by meat analogue member 0100 as illustrated in FIG. 1. The surface area examples that arrows 1203/1204/1205 point out indicate dried-meat-like textures.

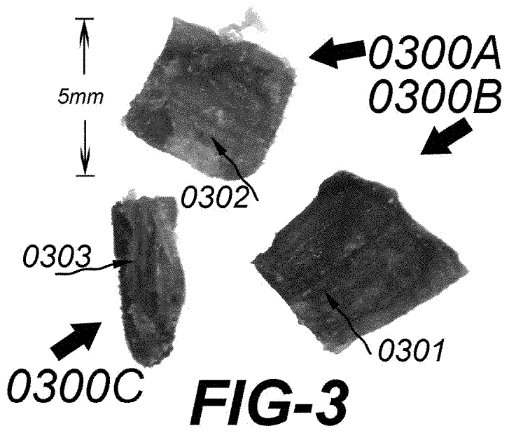

As another aspect of the present invention, an edible pet chew is provided in a form of rawhide munchy product which incorporates/combines bits made of animal hide sheet and tiny chunks/bits made of plant based meat-free meat analogue, where the meat analogue bits are interspersed into the body of the munchy product. The body of the rawhide munchy product includes a visible exterior surface and an invisible interior, where some of the meat analogue tiny chunks are located on the visible exterior surface (a portion of the chunks may extends to the interior) and other tiny chunks located completely in the interior being invisible. Preferably, the meat analogue tiny chunks are formed of or made of textured vegetable protein TVP material. The animal hide bits may be a plurality of tiny animal hide sheets and the meat analogue tiny chuck member is in plurality as well. The animal hide bits primarily or substantially form the rawhide munchy product, occupying at least 50% weight of the munchy product. Alternatively, the proportion of the member of rawhide sheet bits to the member of meat analogue chunks in finished product by weight is in the approximate range between 1:5 and 30:1, and preferably, but not necessarily, between 3:1 and 20:1. A binder/adherent material (preferably a plant derived glutinous material, such as glutinous rice flour paste and plant starch) may be applied to the rawhide bits/meat analogue bits composition holding the animal hide bits and meat analogue bits together firmly. Generally, the rawhide munchy product chew function is primarily or substantially provided by the animal hide bits and binder material. Animal hide bits are prepared by for example grinding/cutting hide sheets to small pieces. Meat analogue bits may be prepared by grinding a larger meat analogue piece like the one 0100A in FIG. 1 or the one 0400A/0400B in FIG. 4. Preferably, the rawhide munchy product is formed by extrusion, pressing or molding process (molding process typically with pressure). As an embodiment to produce the meat analogue bits as shown in FIG. 3, the meat analogue tiny-chunk members 0300A/0300B/0300C are made of a plant based material (preferably meat-free) imitating appearance and texture of tiny-chunks of traditional whole muscle jerky. The surface area examples that arrows 0301/0302/0303 point out indicate fiber-like or wrinkle-like textures. Surface area 0303 is a breakage part of the meat analogue tiny chunk member 0300C having its internal structure exposed, which makes its internal fibrous tissue structure visible. The munchy pet chew is formed by a process ,such as extruding and molding.

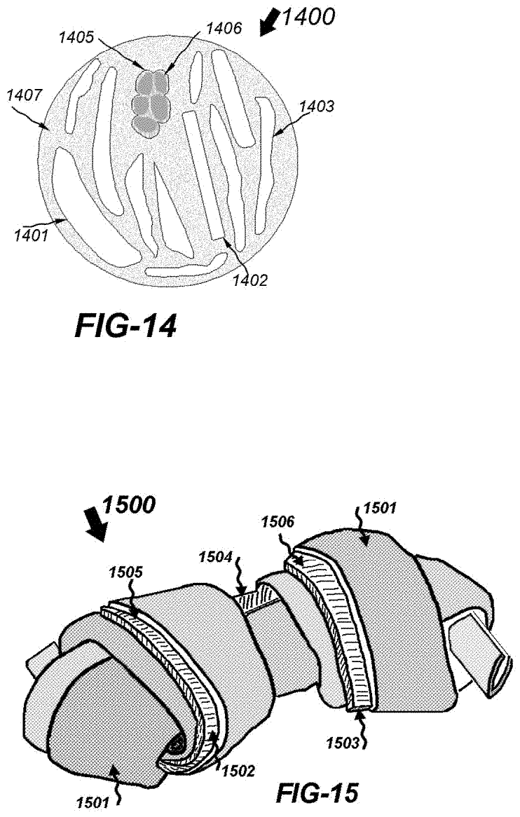

Now referring to FIG. 13, another edible pet chew according to an embodiment of the present invention is illustrated. A rawhide munchy product 1300 made of a composite of animal hide bits and meat-free plant based meat analogue bits (tiny chunks). The components 1301/1302/1303/1304 are some examples of the animal hide bits and there could be hundreds of hide bits like the animal hide bits 1301/1302/1303/1304 in various sizes. And, the components 1305/1306/1307 with jerky-like surface texture are some examples of the meat analogue bits and there could be tens of meat analogue bits like 1305/1306/1307 in various sizes interspersed into the rawhide munchy product body 1300. 1308 refers to a part of glutinous rice paste binder holding all the components together. The rawhide munchy product 1300 composite has about 80% by weight animal hide bits, about 10% meat analogue tiny chunks and about 10% glutinous rice paste material. When the rawhide munchy product 1300 is served to a dog, the dog takes an initial interest in it mainly because of the exposed surface of meat analogue member such as 1306 or the ones appearing at the end of the rawhide munchy product 1300. These exposed members/components may attract the dog visually and by odor, enticing him to initiate his gnawing jobs. And then he discovers that another meat analogue member extending further into the interior body working as a fresh attractant to him. Because of the structure of the rawhide bits and binder in the chew toy (rawhide munchy product) 1300, the dog cannot simply pull out the meat analogue by leaving the remaining rawhide body behind. In this pattern, the dog is occupied by the pet chew being constantly enticed to reveal additional ones of the meat analogue member until the whole chew toy is done. FIG. 14 illustrates a cross section view of the rawhide munchy product 1300. The components 1401/1402/1403 are some examples of the animal hide bits and the component 1405, an example of meat analogue tiny chunk members. 1406 shows an internal fiber-like structure creating a surface texture of the meat analogue tiny chunk 1405 similar to meat jerky. 1407 refers to glutinous rice paste binder.

Here comes an aspect of the present invention. In this aspect, the edible pet chew includes a plant based chewy sheet member and a plant based meat-free meat analogue member, where the meat analogue member and chewy sheet member is assembled. Alternatively, the proportion of the member of chewy sheet to the member of meat analogue in finished product by weight is in the approximate range between 1:5 and 30:1. Preferably, the weight of the chewy sheet accounts for at least 20% (more typically at least 50%) of the total weight of the edible pet chew product. Preferably, the plant based chewy sheet is an extruded one being formed by extrusion process. Preferably, the plant based chewy sheet is a rawhide free material. Preferably, the plant based chewy sheet is meat-free as well as the meat analogue does, thus creating a whole meat-free pet chew product. It is worth mentioning that all prior arts are silent about a whole meat-free dog chew formed primarily of a plant based chewy sheet. Preferably, the chewy sheet is free of meat by-products. And preferably, but not necessarily, the chewy sheet is free of animal ingredient.

As an embodiment of this aspect, a plant based meat-free meat analogue member wraps about a plant based chewy sheet member, where a portion of the chewy sheet member preferably is exposed without being covered by the meat analogue member. In this configuration, the chewy sheet member primarily or substantially forms the pet chew product. Preferably, the meat analogue is in a sheet form imitating ground-and-formed jerky sheet like jerky 0400B as shown in FIG. 4. Thus it creates a pet chew product with a first sheet member of plant based chewy sheet and a second sheet member of plant based meat-free meat analogue member. Alternatively, the meat analogue is in a form imitating traditional whole muscle jerky, which may not be in a sheet form. Preferably, no portion of the meat analogue is concealed by the chewy sheet member.

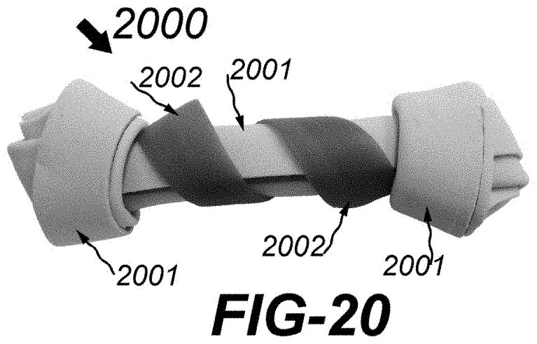

Now referring to FIG. 20, another edible pet chew according to an embodiment of the present invention is illustrated. A rawhide-free plant based chewy sheet pet chew 2000 is formed in knotted bone configuration with a plant based chewy sheet member and a meat-free plant based meat analogue sheet member wrapping about the chewy sheet member. The plant based chewy sheet is folded or rolled longitudinally and is knotted at first and second longitudinal ends, where the first and second longitudinal ends have knots thereat respectively forming a knotted bone chew product; then a second sheet member of meat analogue wraps about the knotted bone chew product at about the middle part of the bone. Member 2001 is a rawhide-free plant based chewy sheet and Member 2002 is meat-free meat analogue sheet member imitating the appearance and texture of ground-and-formed jerky sheet. The area examples that arrow 2001 point out indicate exposed portions of the plant based chewy sheet member without being covered by the meat analogue. Alternatively, the meat analogue sheet may be replaced with a meat analogue chunk imitating traditional whole muscle jerky rather than ground-and-formed one.

As yet another embodiment of this aspect, a plant based meat-free meat analogue is wrapped into a plant based chewy sheet member with a portion of the meat analogue member protruding at the seam of the chewy sheet piece. In this configuration, the chewy sheet forms the outer layer of the product including a longitudinal seam therein. The meat analogue member forms an inner member and is substantially retained within the outer layer. A portion of the inner member extends through the seam in the outer layer and is partially exposed outside the outer layer. Preferably there are a plurality of meat analogues wrapped in the chewy sheet member. Alternatively, the meat analogue is in a sheet form imitating ground-and-formed meat jerky. Alternatively, the meat analogue imitates a piece of traditional whole muscle meat jerky with internal fibrous structure texture.

Now referring to FIG. 15, another edible pet chew according to an embodiment of the present invention is illustrated. A plant based chewy sheet pet chew 1500 is formed in knotted bone configuration with a plant based chewy sheet and meat-free plant based meat analogue members wrapped therein. The plant based chewy sheet is folded or rolled longitudinally with the meat analogue member and is knotted at first and second longitudinal ends, where the first and second longitudinal ends have knots thereat respectively. The chewy sheet substantially serves as the outer layer of the pet chew. Member 1501 is a plant based chewy sheet and 1502/1503/1504 are meat-free meat analogue members imitating the appearance and texture of traditional whole muscle jerky. The plant based chewy sheet 1501 substantially forms the outer layer of the product and the meat analogue 1502/1503/1504, the inner layers. Now referring to the meat analogue member 1502, it visually resembles a piece of meat jerky. It has fibrous tissue structure on the surface and internal part resembling meat jerky. The surface area examples that arrows 1505/1506 point out indicate fiber-like or wrinkle-like textures.

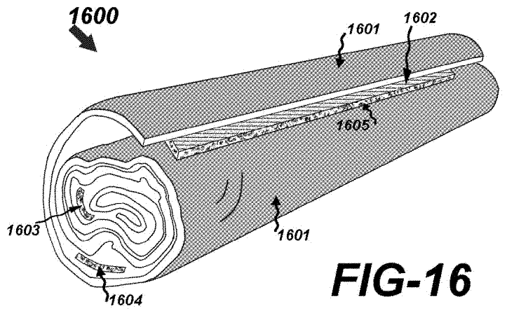

As shown in FIG. 16, another edible pet chew according to an embodiment of the present invention is illustrated. A plant based chewy sheet pet chew 1600 is formed in cylinder-roll-shaped configuration with a plant based chewy sheet and a meat-free plant based meat analogue members wrapped therein. The plant based chewy sheet 1601 substantially serves as the outer layer of the pet chew. Member 1601 is the chewy sheet and member 1602/1603/1604 are meat-free meat analogue members imitating the appearance and texture of ground-and-formed jerky. The plant based chewy sheet 1601 substantially forms the outer layer of the product and the meat analogue 1602/1603/1604, the inner layers. Now referring to the meat analogue member 1602, it visually resembles a ground-and-formed jerky with relatively smoother surface texture imitating ground-and-formed jerky. Alternatively, the meat analogue slightly has internal fiber-like structure visually similar to a certain ground-and-formed jerky. The area that arrow 1605 points out shows an example of the kind of internal fiber-like textures.

As a formula embodiment to produce the plant based chewy sheet member of the present invention, the ingredients to form the plant based chewy sheet member include Potato starch (63%), Corn starch (10%), Vegetable glycerin (10%), Modified vegetable starch (8%), Yeast extract (2%), Sorbitol (3%), Pea protein isolate (2%), Dextrin (1.5%), Maltodextrin (0.2%), Hydrolyzed vegetable protein HVP (0.2%), Coloring (0.08%) and Potassium sorbate (0.02%). A preferred process to form this plant chew sheet is extrusion. This formula is a plant based one. It is free of animal hide material. It is free of meat ingredient, free of meat by-products and free of animal ingredients.

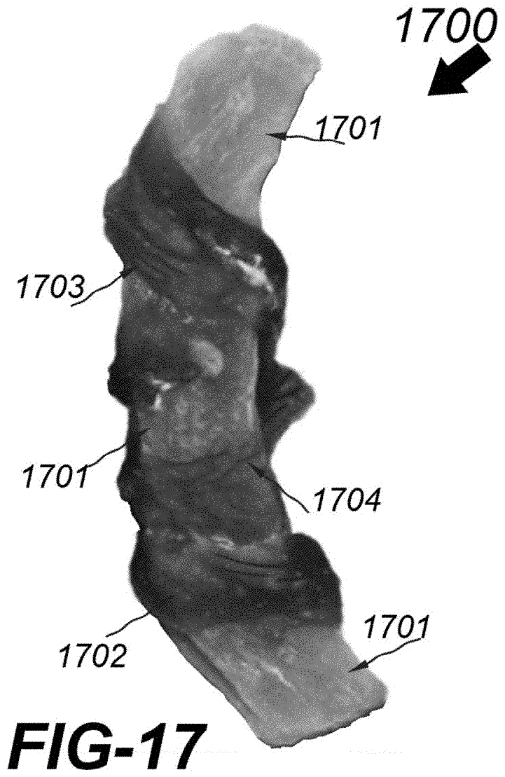

In yet another aspect of the present invention, a pet treat is provided incorporating a meat-free dried natural plant piece member and a meat-free meat analogue member, where the meat-free meat analogue member wraps about the meat-free natural plant piece member, where a portion of the plant piece member is exposed outside. Alternatively, the proportion of the member of natural plant piece member to the member of meat analogue in finished product by weight is in the approximate range between 1:5 and 30:1. Preferably the weight of the plant piece member accounts for at least 20% (more typically at least 50%) of the total weight of the pet treat product. Preferably, the meat analogue having aligned fibrous structure imitating traditional whole muscle jerky. Now referring to FIG. 17, 1700 is a pet treat according to an embodiment of the present invention made of a dried sweet potato strip 1701 with a meat-free meat analogue member 1702 wrapping about it. The meat analogue member 1702 imitates dried meat jerky strips. The surface area examples that arrows 1703/1704 point out indicate fiber-like or wrinkled textures.

In yet another aspect of the present invention, an edible pet chew is provided incorporating a plant based extruded or injection-formed chewy piece member and a meat-free meat analogue member, where the meat analogue member wraps about the chewy piece member. Preferably, a portion of the chewy piece member is exposed without being covered by the meat analogue. Alternatively, the proportion of the member of chewy piece member to the member of meat analogue in finished product by weight is in the approximate range between 1:5 and 30:1. Preferably, the weight of the chewy piece member accounts for at least 20% (more typically at least 50%) of the total weight of the edible pet chew product. Preferably, the plant based extruded or injection-formed chewy piece member is meat free.

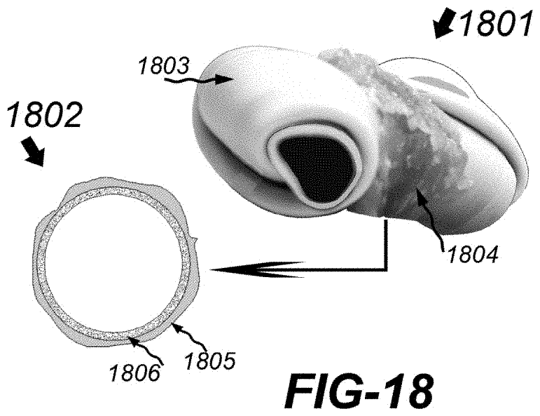

Now referring to FIG. 18, another edible pet chew according to an embodiment of the present invention is illustrated. A plant based extruded chewy tube piece chew 1801 in knotted bone configuration with plant based meat analogue member is formed, where the meat analogue member wraps about the chewy piece member. Chewy piece 1803 is formed by extrusion process in a hollow-tube-like or pipe-like form before being applied with the meat analogue member. The meat analogue member imitates traditional dried meat jerky strips. The chewy piece 1803 is a plant based chewy piece and member 1804 is a plant based meat-free meat analogue member. Now referring to the meat analogue member 1804, it visually resembles dried meat jerky strips with surface texture similar to that of a jerky. It may have fibrous tissue structure on the surface similar to meat jerky. View 1802 is a cross section view of the chew product 1801 at the position of the middle of the bone “diaphysis”. Member 1806 is the tube-like chewy piece with a cross section view like a circle, where meat analogue 1805 wraps about the tube-like chewy piece 1806. As a formula embodiment to produce the chewy piece member, the formula can be identical to the formula embodiment as aforementioned to form a plant based chewy sheet.

It should be noted that the term of “tube” or “pipe” in the present invention generally refers to a long hollow object that is usually round. Typical cross section of the tube/pipe is in an outline being round or circular. But outline shape of the tube/pipe cross section may be in various shapes, such as an oval shape, a shape resembling arabic numerals “8” and irregular shapes. Preferably, thickness of the wall of the “tube” or “pipe” is substantially homogeneous.

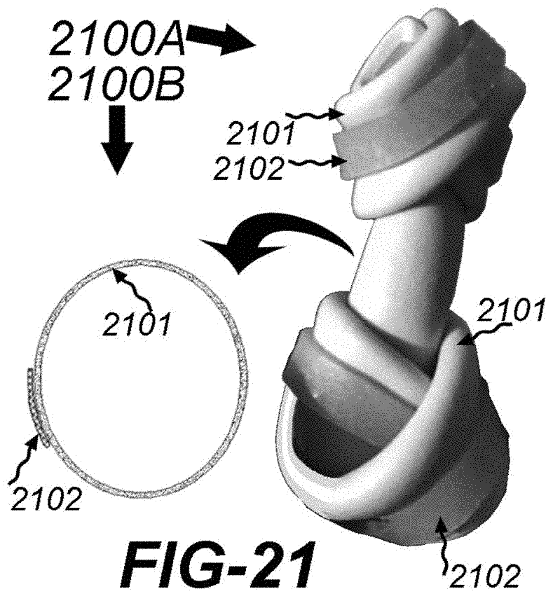

In some embodiments of the present invention, an extruded tube-formed chewy piece edible pet chew is provided. In this product configuration, a first member of meat analogue is placed against a second member of tube-formed chewy piece longitudinally and the members are formed into a composite assembly, where the first member and the second form alternating layers in the composite assembly in finished product. Alternatively, the proportion of the member of “tube chewy piece” to the member of “meat analogue” assembled together is in the approximate range between 1:5 and 100:1 (more typically between 1:5 and 50:1) by weight in finished product. Now referring to FIG. 21, another edible pet chew according to an embodiment of the present invention is illustrated. A plant based extruded chewy tube piece chew 2100A in knotted bone configuration with plant based meat analogue strip member is formed, where the meat analogue strip member is knotted with the chewy piece member forming alternating layers of the pet chew 2100A. Chewy piece 2101 is formed by extrusion process in a hollow-tube-like or pipe-like form before being applied with the meat analogue member. The meat analogue strip/sheet member imitates ground-and formed meat jerky strip. Member 2101 is a plant based chewy piece and member 2102 is a plant based meat-free meat analogue member. Now referring to the meat analogue member 2102, it visually resembles dried meat jerky strips with surface texture similar to that of a ground-and-formed meat jerky. It may have fibrous tissue structure on the surface similar to a ground-and-formed jerky. View 2100B is a cross section view of the chew product 2100A at the position of the middle of the bone “diaphysis”. The chewy piece 2101 in the cross section view 2100B is the tube-like chewy piece with a cross section view like an oval loop. The member 2102 in 2100B is a meat analogue member. As a formula embodiment to produce the chewy piece member, the formula can be identical to the formula embodiment as aforementioned to form a plant based chewy sheet.

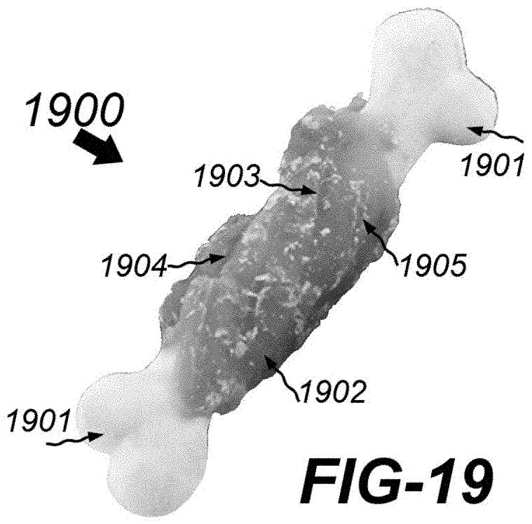

As shown in FIG. 19, yet another edible pet chew according to an embodiment of the present invention is illustrated. A plant based injection-processed chewy piece chew 1900 in bone configuration with plant protein based meat analogue member is formed, where the meat analogue member wraps about the chewy piece member. Chewy piece 1901 is formed by injection process in a bone-like form before being applied with the meat analogue member 1902. The meat analogue member 1902 imitates traditional dried meat jerky strips. Member 1901 is a plant based chewy piece and member 1902 is a plant protein based meat-free meat analogue member. Now referring to the meat analogue member 1902, it visually resembles dried meat jerky strips with surface texture similar to that of a jerky. It may have fibrous tissue structure on the surface similar to meat jerky. The surface area examples that arrows 1903/1904/1905 point out indicate dried-meat-like surface textures. As a formula embodiment to produce the plant based injection-processed chewy piece member of the present invention, the ingredients to form it include Brown rice flour (80%), Vegetable glycerin (10%), Pea flour (5%), Tapioca starch (2%), Hydrolyzed chicken protein (2%, classified as animal ingredient but still meat free), Carrageenan (0.5%), Cinnamon (0.2%), Calcium carbonate (0.1%), Brewer dried yeast (0.1%), Parsley powder (0.05%), Peppermint oil (0.02%), Citric Acid (0.01%), Rosemary oil (0.01%) and Mixed tocopherols (0.01%). A preferred process to form this chewy piece member is injection or extrusion. This formula is a plant based one. It is free of meat ingredient, free of meat by-products.

In yet another aspect of the present invention, a manufacturing process embodiment is provided by the present invention. A preferred process for manufacturing an edible pet chew of the present invention with a meat analogue member and a chewy sheet member is provided. The process includes the following steps: A), Prepare a chewy sheet, such as traditional rawhide sheet. B), Prepare a meat analogue member such as a textured vegetable protein (TVP) piece, which includes: i, preparing composition materials in a formula as aforementioned and have them preconditioned with adjusted moisture. ii, having them mixed well in a blender. iii, feeding the composition material into an extruder. iv, in the extruder, the composition material is treated with high temperature, such as a variation temperature of 80° C. to 190° C. in different portions of the extruder, and high pressure; fibrous structure is generated herein; cut to a predetermined shape such as a rectangular one. v, cooling. vi. having it dried and thus getting a meat analogue member ready. C), Have the chewy sheet and meat analogue member assembled in a pre-determined relationship, such as meat analogue being wrapped in the chewy sheet member. D), Have it low temperature heat dried in a oven to a finished product with final moisture preferably between 6%-20%.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. An edible pet chew, comprising:
a plant based meat-free meat analogue member, wherein said plant based meat-free meat analogue member imitates a characteristic of dried meat, wherein said plant based meat-free meat analogue member comprises at least 35% plant ingredient on an as fed basis by weight, wherein said characteristic of dried meat being imitated by said plant based meat-free meat analogue member comprises a fibrous structure texture of dried meat; and
a chewy sheet member, wherein said chewy sheet member and said plant based meat-free meat analogue member are assembled together, wherein chewing function of said edible pet chew is substantially provided by said chewy sheet member.

2. The edible pet chew, as recited in claim 1, wherein said plant based meat-free meat analogue member is plant protein based, wherein said plant based meat-free meat analogue member comprises at least 12% plant protein by weight on an as fed basis, wherein said characteristic of dried meat being imitated by said plant based meat-free meat analogue member comprises a surface texture appearance of dried meat.

3. The edible pet chew, as recited in claim 2, wherein said plant based meat-free meat analogue member is made of Textured Vegetable Protein (TVP) material, wherein said plant based meat-free meat analogue member has a surface texture visually resembling a piece of dried meat jerky, wherein said surface texture comprises a wrinkled texture.

4. The edible pet chew, as recited in claim 2, wherein said chewy sheet member is a rawhide sheet member.

5. The edible pet chew, as recited in claim 4, wherein said plant based meat-free meat analogue member is substantially wrapped in said rawhide sheet member, wherein at least a portion of said plant based meat-free meat analogue member is concealed by said rawhide sheet member, wherein said rawhide sheet member is a traditional rawhide sheet member.

6. The edible pet chew, as recited in claim 5, wherein said rawhide sheet member substantially forms an outer layer of said edible pet chew product, wherein said plant based meat-free meat analogue member forms an inner member of said edible pet chew product, wherein the proportion of said rawhide sheet member to said plant based meat-free meat analogue member in finished product is in a range between 1:5 and 30:1 by weight.

7. The edible pet chew, as recited in claim 5, wherein said rawhide sheet member is folded or rolled longitudinally with said plant based meat-free meat analogue member and is knotted at first and second longitudinal ends, wherein the first and second longitudinal ends have knots thereat respectively.

8. The edible pet chew, as recited in claim 4, wherein said rawhide sheet member and said plant based meat-free meat analogue member are placed against each other into a composite assembly, wherein said plant based meat-free meat analogue member and said rawhide sheet member form alternating layers in the composite assembly, wherein the proportion of said rawhide sheet member to said plant based meat-free meat analogue member in finished product is in a range between 1:5 and 30:1 by weight.

9. The edible pet chew, as recited in claim 4, wherein said plant based meat-free meat analogue member substantially wraps about said rawhide sheet member, wherein the proportion of said rawhide sheet member to said plant based meat-free meat analogue member in finished product is in a range between 1:5 and 30:1 by weight.

10. The edible pet chew, as recited in claim 3 wherein said dried meat jerky being imitated by said plant based meat-free meat analogue member is a dried traditional whole muscle meat jerky or a ground-and-reformed meat jerky, wherein moisture content of said plant based meat-free meat analogue member ranges from about 6% to 20%.

11. The edible pet chew, as recited in claim 3, wherein said dried meat jerky being imitated by said plant based meat-free meat analogue member is a dried traditional whole muscle meat jerky.

12. The edible pet chew, as recited in claim 11, wherein said plant based meat-free meat analogue member has an internal fiber-like structure visually similar to that of a dried traditional whole muscle meat jerky, wherein said internal fiber-like structure comprises manually separable meat-jerky-like aligned fibers resembling a dried traditional whole muscle meat jerky.

13. The edible pet chew, as recited in claim 3, wherein said plant based meat-free meat analogue member comprises a flavor ingredient in its formula to enhance palatability, wherein said flavor ingredient is selected from the group consisting of: dried brewer yeast, yeast extract, natural flavor, hydrolyzed vegetable protein HVP, enzyme hydrolyzed vegetable protein EVP, leghemoglobin, meat extract and an animal-derived hydrolyzed animal protein HAP.

14. The edible pet chew, as recited in claim 3, wherein said plant based meat-free meat analogue member is free of gluten material and free of animal ingredients, wherein a formula of said plant based meat-free meat analogue member further comprises a nutrient element as dietary supplement selected from the group consisting of minerals, vitamins, carbohydrates and dietary fibers, wherein said plant based meat-free meat analogue member is formed by a process selected from the group consisting of extrusion, molding, injection, pressing, rolling and 3D printing.

15. The edible pet chew, as recited in claim 4, wherein said rawhide sheet member is in a form of tiny bits, wherein said tiny bits of rawhide sheet member are plural in quantity, wherein said tiny bits of rawhide sheet member substantially form a rawhide munchy product, wherein said rawhide munchy product comprises at least 50% said tiny bits of rawhide by weight, wherein said plant based meat-free meat analogue member is in a form of tiny chunks, wherein said tiny chunks of plant based meat-free meat analogue member are plural in quantity, wherein said tiny chunks of plant based meat-free meat analogue member are interspersed into the body of said rawhide munchy product.

16. The edible pet chew, as recited in claim 15, wherein said rawhide munchy product further comprises a binder material in its formula, wherein the proportion of said tiny bits of rawhide sheet member to said tiny chunks of plant based meat-free meat analogue member in finished product by weight is in a range between 1:5 and 30:1.

17. The edible pet chew, as recited in claim 2, wherein said chewy sheet member is a rawhide-free plant based extruded chewy sheet member, wherein said chewy sheet member comprises at least 35% plant ingredient on a as fed basis, wherein said chewy sheet member substantially forms said edible pet chew product, wherein the proportion of said chew sheet member to said plant based meat-free meat analogue member in finished product is in a range between 1:5 and 30:1 by weight.

18. The edible pet chew, as recited in claim 17, wherein said plant based meat-free meat analogue member wraps about said chewy sheet member, wherein a portion of said chewy sheet member is exposed without being covered by said plant based meat-free meat analogue member, wherein said plant based meat-free meat analogue member imitates a dried traditional whole muscle meat jerky, wherein said plant based meat-free meat analogue member is made of Textured Vegetable Protein (TVP) material, wherein said plant based meat-free meat analogue member has a surface texture visually resembling whole muscle meat jerky, wherein said plant based meat-free meat analogue member has a wrinkled surface, wherein said plant based meat-free meat analogue member has an internal fiber-like structure visually similar to that of a dried traditional whole muscle meat jerky, wherein said fiber-like structure comprises manually separable meat-jerky-like aligned fibers resembling a dried traditional whole muscle meat jerky.

19. The edible pet chew, as recited in claim 17, wherein said plant based meat-free meat analogue member is substantially wrapped in said chewy sheet member, wherein at least a portion of said plant based meat-free meat analogue member is concealed by said chewy sheet member, wherein said plant based meat-free meat analogue member has a wrinkled surface, wherein said plant based meat-free meat analogue member imitates a characteristic of dried traditional whole muscle meat jerk or ground-and-formed jerky, wherein said characteristic of dried traditional whole muscle meat jerk being imitated by said plant based meat-free meat analogue member comprises internal fiber-like structure.

20. An edible pet chew, comprising:
a plurality of tiny chunks of plant based meat-free meat analogue, wherein said plant based meat-free meat analogue tiny chunks imitate a characteristic of dried meat chunks, wherein said characteristic of dried meat chunks being imitated by said plant based meat-free meat analogue tiny chunks comprises the appearance and texture of dried meat chunks;
a plurality of bits of rawhide; and
a binder material, wherein said bits of rawhide, said tiny chunks of plant based meat-free meat analogue and said binder material together form a rawhide munchy product, wherein chewing function of said rawhide munchy product is substantially provided by said bits of rawhide and said binder material, wherein said plant based meat-free meat analogue tiny chunks are interspersed into the body of said rawhide munchy product.

21. The edible pet chew, as recited in claim 20, wherein said plant based meat-free meat analogue tiny chunks are plant protein based, wherein said plant based meat-free meat analogue tiny chunks comprise at least 12% plant protein by weight on an as fed basis, wherein said plant based meat-free meat analogue tiny chunks have a surface texture visually resembling a dried meat jerky chunk, wherein said plant based meat-free meat analogue tiny chunks imitate a characteristic of fibrous structure texture of a dried meat chunk.

22. The edible pet chew, as recited in claim 21, wherein said plant based meat-free meat analogue tiny chunks are made of Textured Vegetable Protein (TVP) material, wherein the proportion of said bits of rawhide to said tiny chunks of plant based meat-free meat analogue in finished product by weight is in a range between 1:5 and 30:1, wherein said rawhide munchy product comprises at least 50% said bits of rawhide by weight.

23. The edible pet chew, as recited in claim 20, wherein said bits of rawhide are prepared by grinding rawhide sheet materials, wherein size of each of said bits of rawhide is between 0.04 mm² to 400 mm², wherein said rawhide munchy product is formed by a process selected from the group consisting of extrusion, molding and pressing.
